(19) United States
(12) Patent Application Publication
(10) Pub. No.: US 2026/0222594 A1
(43) Pub. Date: Jul. 30, 2026

(54) REPRESENTATIVE PREDICTION MODE OF A BLOCK OF PIXELS

(71) Applicant: MEDIATEK INC., Hsinchu City (TW)

(72) Inventors: Man-Shu CHIANG, Hsinchu City (TW); Chih-Wei HSU, Hsinchu City (TW); Tzu-Der CHUANG, Hsinchu City (TW)

(21) Appl. No.: 19/145,028

(22) PCT Filed: Jan. 2, 2024
(86) PCT No.: PCT/CN2024/070121

§ 371 Date: Jul. 1, 2025

Related U.S. Application Data
(60) Provisional application No. 63/478,199, filed on Jan. 3, 2023.
(60) Provisional application No. 63/480,325, filed on Jan. 18, 2023.

(51) Int. Cl. H04N 19/159; H04N 19/105; H04N 19/176; H04N 19/196; H04N 19/593

(52) U.S. Cl. CPC H04N 19/159; H04N 19/105; H04N 19/176; H04N 19/196; H04N 19/593

(57) ABSTRACT

A method for generating and using a representative prediction mode of a currently coded pixel block is provided. A video coder receives data for a block of pixels to be encoded or decoded as a current block of a current picture of a video. The video coder generates a predictor for the current block using a first prediction mode. The video coder identifies a second prediction mode that is a representative prediction mode of the current block. The video coder encodes or decodes the current block by using the generated predictor for the current block and the representative prediction mode. The representative prediction mode maybe used to select a transform for the prediction residual. The representative prediction mode may also be used for coding a subsequent block.

### CROSS REFERENCE TO RELATED PATENT APPLICATION(S)

The present disclosure is part of a non-provisional application that claims the priority benefit of U.S. Provisional Patent Application Nos. 63/478,199 and 63/480,325, filed on 3 Jan. 2023 and 18 Jan. 2023, respectively. Contents of above-listed applications are herein incorporated by reference.

### TECHNICAL FIELD

The present disclosure relates generally to video coding. In particular, the present disclosure relates to methods of coding pixel blocks by intra-prediction or component prediction.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU. Beyond the inter coding features in HEVC, VVC includes a number of new and refined inter prediction coding tools listed as follows: Extended merge prediction, Merge mode with MVD (MMVD), Symmetric MVD (SMVD) signalling, Affine motion compensated prediction, Subblock-based temporal motion vector prediction (SbTMVP), Adaptive motion vector resolution (AMVR), Motion field storage: 1/16th luma sample MV storage and 8×8 motion field compression, Bi-prediction with CU-level weight (BCW), Bi-directional optical flow (BDOF), Decoder side motion vector refinement (DMVR), Geometric partitioning mode (GPM), Combined inter and intra prediction (CIIP).

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for generating and using a representative prediction mode of a currently coded pixel block. A video coder receives data for a block of pixels to be encoded or decoded as a current block of a current picture of a video. The video coder generates a predictor for the current block using a first prediction mode. The video coder identifies a second prediction mode as a representative prediction mode of the current block. The video coder encodes or decodes the current block by using the generated predictor for the current block and the representative prediction mode. The representative prediction mode maybe used to select a transform for the prediction residual. The representative prediction mode may also be used for coding a subsequent block.

In some embodiments, the first prediction mode is not a directional intra-prediction mode. The first prediction mode may be a regular intra mode, special intra mode, or non-intra mode. In some embodiments, the predictor is generated by matrix multiplication of a pre-defined or derived matrix with a set of input samples derived from samples neighboring the current block. In some embodiments, the current block is a chroma component block and the predictor for the current block is generated by applying a cross-component model to a collocated luma component block. In some embodiments, the predictor for the current block is generated based on a reference block that is identified by matching a first template region neighboring the current block with a second template region in the current picture or in a reference picture. In some embodiments, the predictor is generated by combining predictions from multiple prediction hypotheses.

In some embodiments, the predictor is generated by using a block vector or a motion vector to identify a reference region in the current picture or in a reference picture and the representative prediction mode is an intra prediction mode used to code pixel samples within or neighboring the reference region. In some embodiments, the video coder identifies the representative prediction mode by searching a plurality of predefined positions within or neighboring the reference region in a predefined order for determining the representative prediction mode.

In some embodiments, the representative prediction mode is selected from a plurality of intra prediction modes based on costs, where the cost of an intra prediction mode is a difference between reconstructed samples and predicted samples of a neighboring region for the current block and the predicted samples of the neighboring region for the current block is generated based on the intra prediction mode. In some embodiments, the representative prediction mode is identified by deriving a plurality of histograms of gradients (HoGs) for a plurality of intra prediction modes, and HoG for an intra prediction mode is derived based on a pre-defined set of the predictor for the current block.

In some embodiments, the representative prediction mode is used to select a primary transform and/or a secondary transform. In some embodiments, the representative intra-prediction mode is used to select a transform set, a transpose flag, or both for non-separable transform. In some embodiments, the video coder provides the representative prediction mode for use as a most probable mode (MPM) for coding a subsequent block. In some embodiments, the current block is a luma component block and the representative prediction mode is used to encode a collocated chroma component block in chroma DM mode, by e.g., generating an intra prediction predictor of the chroma block.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows the intra-prediction modes in different directions.

FIGS. 2A-B conceptually illustrate top and left reference templates with extended lengths for supporting wide-angular direction mode for non-square blocks of different aspect ratios.

FIG. 3 illustrates using decoder-side intra mode derivation (DIMD) to implicitly derive an intra prediction mode for the current block.

FIG. 4 illustrates using template-based intra mode derivation (TIMD) to implicitly derive an intra prediction mode for a current block.

FIG. 5 conceptually illustrates chroma and luma samples that are used for derivation of linear model parameters.

FIG. 6 shows an example of classifying the neighbouring samples into two groups.

FIG. 7 conceptually illustrates the spatial components of a convolutional filter.

FIG. 8 illustrates a reference area that is used to derive filter coefficients for a convolution model for a current block.

FIG. 9 shows a table for transform set selection.

FIG. 10 conceptually illustrates template matching prediction (TMP).

FIG. 11 conceptually illustrates using the predictor of the current block to determine the representative prediction mode for the current block.

FIG. 12 shows the pred-defined prediction units in a reference region that are used to derive the representative intra-prediction for the current block.

FIG. 13 illustrates an example video encoder may implement representative prediction modes for blocks of pixels being encoded.

FIG. 14 illustrates portions of the video encoder that implement the representative prediction mode.

FIG. 15 conceptually illustrates a process for generating and using representative intra prediction of the current block.

FIG. 16 illustrates an example video decoder may implement representative prediction modes for blocks of pixels being decoded.

FIG. 17 illustrates portions of the video decoder that implement the representative prediction mode.

FIG. 18 conceptually illustrates a process for generating and using representative intra prediction of the current block.

FIG. 19 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Intra Prediction Modes

Intra-prediction method exploits one or more reference tiers adjacent to the current prediction unit (PU) and at least one of the intra-prediction modes to generate the predictors for the current PU. The Intra-prediction direction can be chosen among a mode set containing multiple prediction directions. For each PU coded by Intra-prediction, one index will be used and encoded to select one of the intra-prediction modes. The corresponding prediction will be generated and then the residuals can be derived and transformed.

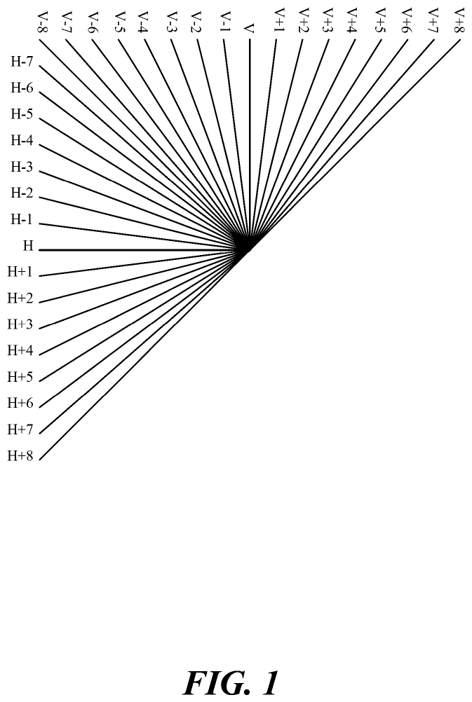

FIG. 1 shows the intra-prediction modes in different directions. These intra-prediction modes are referred to as directional modes and do not include DC mode or Planar mode. As illustrated, there are 33 directional modes (V: vertical direction; H: horizontal direction), so H, H+1~H+8, H-1~H−7, V, V+1~V+8, V−1~V−8 are used. Generally directional modes can be represented as either as H+k or V+k modes, where k=1, ±2, . . . , ±8. Each of such intra-prediction mode can also be referred to as an intra-prediction angle. To capture arbitrary edge directions presented in natural video, the number of directional intra modes may be extended from 33, as used in HEVC, to 65 direction modes so that the range of k is from ±1 to ±16. These denser directional intra prediction modes apply for all block sizes and for both luma and chroma intra predictions. By including DC and Planar modes, the number of intra-prediction mode is 35 (or 67). In one embodiment, a first intra prediction mode which is used to generate a predictor for the current block refers to one or more from DC, Planar, and/or intra directional modes. In another embodiment, a first intra prediction mode is not the only one prediction mode for determining the final predictor of the current block. For example, the final predictor is a blending predictor from a weighted average of multiple hypotheses of predictions. Each hypothesis of prediction is generated using an intra prediction mode which can be any intra prediction mode mentioned in this invention and/or any mode used for prediction generation. In another embodiment, a first intra prediction mode which is used to generate a predictor for the current block refers to any pre-defined matrix and/or model. For example, the matrix of the first intra prediction mode uses the neighboring reconstructed or predicted samples of the current block as the inputs to generate the predictor of the current block. For example, the model of the first intra prediction mode includes model parameters which are derived using the neighboring reconstructed or predicted samples of the current block. For example, when generating the predictor of the current block, the model of the first intra prediction mode uses the neighboring reconstructed or predicted samples of the current block and/or the neighboring reconstructed or predicted samples of the collocated color-component block of the current block and/or the current reconstructed or predicted samples of the collocated color-component block of the current block and/or the current predicted samples of the current block. When the current block corresponds to chroma component such as Cb and/or Cr, the collocated color-component block of the current block corresponds to a collocated luma block which is located using the position of the current block and/or downsampled as the size of the current block. When generating the to-be-predicted sample at position (x, y) of the current block, the to-be-used samples are determined using the position.

Out of the 35 (or 67) intra-prediction modes, some modes (e.g., 3 or 5) are identified as a set of most probable modes (MPM) for intra-prediction in current prediction block. The encoder may reduce bit rate by signaling an index to select one of the MPMs instead of an index to select one of the 35 (or 67) intra-prediction modes. For example, the intra-prediction mode used in the left prediction block and the intra-prediction mode used in the above prediction block are used as MPMs. When the intra-prediction modes in two neighboring blocks use the same intra-prediction mode, the intra-prediction mode can be used as an MPM. When only one of the two neighboring blocks is available and coded in directional mode, the two neighboring directions immediately next to this directional mode can be used as MPMs. DC mode and Planar mode are also considered as MPMs to fill the available spots in the MPM set, especially if the above or top neighboring blocks are not available or not coded in intra-prediction, or if the intra-prediction modes in neighboring blocks are not directional modes. If the intra-prediction mode for current prediction block is one of the modes in the MPM set, 1 or 2 bits are used to signal which one it is. Otherwise, the intra-prediction mode of the current block is not the same as any entry in the MPM set, and the current block will be coded as a non-MPM mode. There are all-together 32 such non-MPM modes and a (5-bit) fixed length coding method is applied to signal this mode.

In one embodiment, the MPM list is constructed based on intra modes of the left and above neighboring blocks. Suppose the mode of the left neighboring block is denoted as Left and the mode of the above neighboring block is denoted as Above, and the unified MPM list may be constructed as follows:
When a neighboring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, Max+2}
If Left and Above are both angular and they are different:
   Set a mode Max as the larger mode in Left and Above
   Set a mode Min as the smaller mode in Left and Above
   If Max—Min is equal to 1:
      MPM list→{Planar, Left, Above, Min−1, Max+1, Min−2}
   Otherwise, if Max−Min is greater than or equal to 62:
      MPM list→{Planar, Left, Above, Min+1, Max−1, Min+2}
   Otherwise, if Max−Min is equal to 2:
      MPM list→{Planar, Left, Above, Min+1, Min−1, Max+1}
   Otherwise:
      MPM list→{Planar, Left, Above, Min−1, Min+1, Max−1}
If Left and Above are both angular and they are the same:
   MPM list→{Planar, Left, Left−1, Left+1, Left−2, Left+2}
      In some embodiments, the MPM list comprises spatial adjacent candidates (including a left neighboring block and/or an above neighboring block) and/or spatial non-adjacent candidates, and/or history-based candidates, and/or temporal candidates, and/or propagation candidates, some default intra prediction modes, some derived modes (with each mode index derived using the mode index of a pre-defined candidate and a pre-defined offset) from some promising intra prediction modes, and/or any subset of available intra prediction modes. Spatial adjacent candidates can be from the left/above/above-left/above-right/bottom-left neighboring blocks of the current block, and/or any subset of the above-mentioned positions. Spatial non-adjacent candidates can be from any pre-defined positions in a search pattern around the current block, and/or any subset of the above-mentioned positions. History-based candidates can be from a history buffer which stores multiple intra prediction mode information of the previous coded blocks which were coded before the current block and have valid intra prediction mode information. The history buffer is empty at a pre-defined timing. For example, the history buffer is empty at the beginning or the end of a slice, CTU/CTB, CTU/CTB row, picture, tile, sequence, and/or any pre-defined unit. Temporal candidates can be from a buffer which stores the intra prediction mode information at a referred reference position in the reference frame (or reference picture) and/or a pre-defined collocated picture, and/or stores the intra prediction mode information at any pre-defined positions nearing the referred reference position. For example, the referred reference position is the collocated block in the collocated picture. For another example, the referred reference position is indicated using the motion information of the neighboring blocks or any pre-defined blocks associated with the current block. Propagation candidates can be from the intra prediction mode information at one or more reference positions referring by the motion information of the neighboring blocks or any pre-defined blocks associated with the current block.

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indices, which are remapped to indices of wide angular modes after parsing.

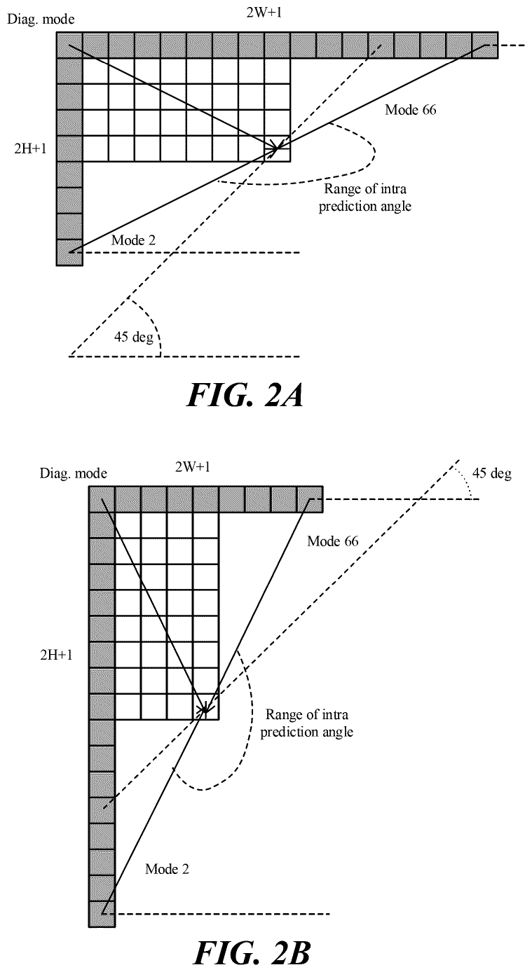

For some embodiments, the total number of intra prediction modes is unchanged, i.e., 67, and the intra mode coding method is unchanged. To support these prediction directions, a top reference template with length 2 W+1 and a left reference template with length 2H+1 are defined. FIGS. 2A-B conceptually illustrate top and left reference templates with extended lengths for supporting wide-angular direction mode for non-square blocks of different aspect ratios.

The number of replaced modes in wide-angular direction mode depends on the aspect ratio of a block. The replaced intra prediction modes for different blocks of different aspect ratios are shown in Table 1 below.

TABLE 1
Intra prediction modes replaced by wide-angular modes

| Aspect ratio | Replaced intra prediction modes |
|---|---|
| W / H == 16 | Modes 2, 3, 4, 5, 6, 7, 8, 9, 10, 11, 12, 13, 14, 15 |
| W / H == 8 | Modes 2, 3, 4, 5, 6, 7, 8, 9, 10, 11, 12, 13 |
| W / H == 4 | Modes 2, 3, 4, 5, 6, 7, 8, 9, 10, 11 |
| W / H == 2 | Modes 2, 3, 4, 5, 6, 7, 8, 9 |
| W / H == 1 | None |
| W / H == ½ | Modes 59, 60, 61, 62, 63, 64, 65, 66 |
| W / H == ¼ | Modes 57, 58, 59, 60, 61, 62, 63, 64, 65, 66 |
| W / H == ⅛ | Modes 55, 56, 57, 58, 59, 60, 61, 62, 63, 64, 65, 66 |
| W / H == 1/16 | Modes 53, 54, 55, 56, 57, 58, 59, 60, 61, 62, 63, 64, |
| | 65, 66 |

### II. Decoder Side Intra Mode Derivation (DIMD)

Decoder-Side Intra Mode Derivation (DIMID) is a technique in which two intra prediction modes/angles/directions are derived from the reconstructed neighbor samples (template) of a block, and those two or more predictors are combined with the planar mode predictor with the weights derived from the gradients. The DIMD mode is used as an alternative prediction mode and is always checked in high-complexity RDO mode. To implicitly derive the intra prediction modes of a blocks, a texture gradient analysis is performed at both encoder and decoder sides. This process starts with an empty Histogram of Gradient (HoG) having 65 entries (or the entries with the size equal to any pre-defined number), corresponding to the 65 angular/directional intra prediction modes (or the available angular intra prediction modes for DIMD). Amplitudes of these entries are determined during the texture gradient analysis.

A video coder performing DIMD performs the following steps: in a first step, the video coder picks a template of T=3 columns and lines from respectively left and above the current block. This area is used as the reference for the gradient based intra prediction modes derivation. In a second step, the horizontal and vertical Sobel filters are applied on all 3×3 window positions, centered on the pixels of the middle line of the template. On each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) ,$$

which can be converted into one of the 65 angular intra prediction modes. Once the intra prediction modes index of current window is derived as idx, the amplitude of its entry in the HoG[idx] is updated by addition of

$$ampl = \vert {G}_{x} \vert + \vert {G}_{y} \vert$$

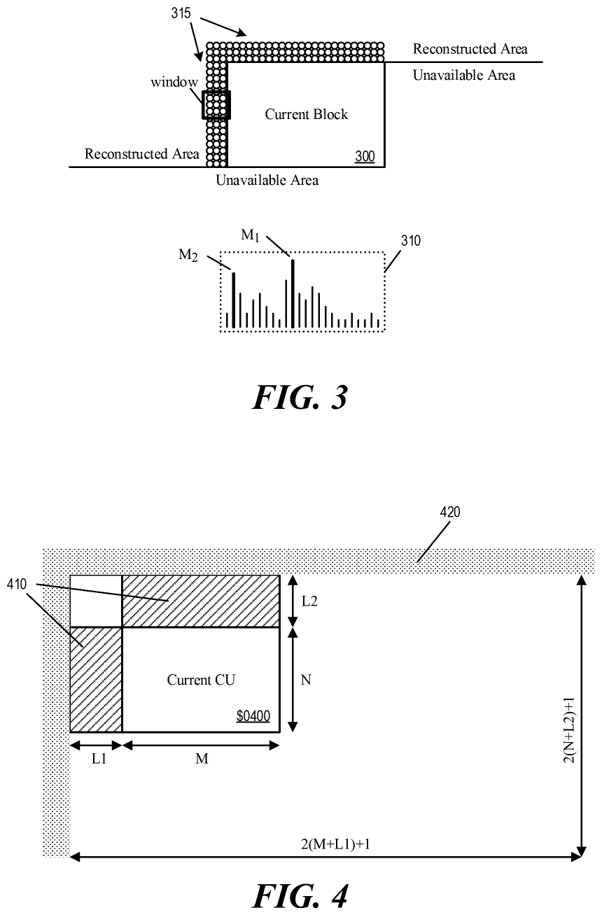

FIG. 3 illustrates using decoder-side intra mode derivation (DEVID) to implicitly derive an intra prediction mode for the current block. The figure shows an example Histogram of Gradient (HoG) 310 that is calculated after applying the above operations on all or any subset of pixel positions in a template 315 that includes neighboring lines of pixel samples around a current block 300. Once the HoG is computed, the indices of the two or more tallest histogram bars (M₁ and M₂) are selected as the two or more implicitly derived intra prediction modes (IPMs) for the block. The predictions of the two or more IPMs are further combined with the prediction of the planar mode as the prediction of DIMD mode. The prediction fusion is applied as a weighted average of the above three or more predictors (M₁ prediction, M₂ prediction (and/or more predictions from other IPMs), and planar mode prediction). To this aim, the weight of planar may be set to 21/64 (~1/3). The remaining weight of 43/64 (~2/3) is then shared between the two or more HoG IPMs, proportionally to the amplitude of their HoG bars. For example of only combining the predictions from M1, M2, and planar, the prediction fusion or combined prediction for DIMD can be:

$${Pred}_{DIMD} = ( 43 * ( w 1 * {pred}_{M 1} + w 2 * {pred}_{M 2} ) + 21 * {pred}_{planar} ) >> 6$$

$$w 1 = {amp}_{M 1} / ( {amp}_{M 1} + {amp}_{M 2} )$$

$$w 2 = {amp}_{M 2} / ( {amp}_{M 1} + {amp}_{M 2} )$$

In addition, the two or more implicitly derived intra prediction modes are added into the most probable modes (MPM) list, so the DIMD process is performed before the MPM list is constructed. The primary derived intra mode of a DIMD block is stored with a block and is used for MPM list construction of the neighboring and/or subsequent blocks.

### III. Template-based Intra Mode Derivation (TIMD)

For mode selection, template matching method can be applied by computing the cost between reconstructed samples and predicting samples. One of the examples is template-based intra mode derivation (TIMD). TIMD is a coding method in which the intra prediction mode of a CU is implicitly derived by using a neighboring template at both encoder and/or decoder, instead of the encoder signaling the exact intra prediction mode to the decoder.

FIG. 4 illustrates using template-based intra mode derivation (TIMD) to implicitly derive an intra prediction mode for a current block 400. As illustrated, the neighboring pixels of the current block 400 is used as template 410. For each candidate intra prediction mode, predicted samples of the template 410 are generated using the reference samples, which are in a L-shape reference region 420 above and left of the template 410 if a candidate intra prediction mode refers to any of DC, planar, and/or directional intra prediction modes. A TM cost for a candidate intra mode cost is calculated based on a difference (e.g., SATD) between reconstructed samples of the template and the prediction samples of the template generated by the candidate intra mode. The candidate intra prediction mode with the minimum cost is selected (as the implicit intra prediction mode derivation in the DIMD mode) and used for intra prediction of the CU. In some embodiments, the candidate intra prediction modes may include 67 intra prediction modes (as in VVC) or extended to 131 intra prediction modes. In some embodiments, MPMs may be used to indicate the directional information of a CU. Thus, to reduce the intra mode search space and utilize the characteristics of a CU, the intra prediction mode is implicitly derived from the MPM list. In some embodiments, the candidate intra prediction modes may include DC, Planar, and/or intra directional modes. In some embodiments, the candidate intra prediction modes may include any intra prediction modes mentioned in this invention and/or any modes used for prediction generation. In some embodiments, the candidate intra prediction modes may include any pre-defined matrixes and/or models. For example, a candidate intra prediction mode refers to the matrix using the neighboring reconstructed or predicted samples of the current block as the inputs to generate the predictor of the current block, and/or using the neighboring reconstructed or predicted samples of the current block as the inputs to generate the predictor of the template of the current block, and/or using the neighboring reconstructed or predicted samples of the template of the current block as the inputs to generate the predictor of the template of the current block. For example, a candidate intra prediction mode refers to model parameters which are derived using the neighboring reconstructed or predicted samples of the current block. For example, when generating the predicted samples of the template of the current block, the candidate intra prediction mode uses the neighboring reconstructed or predicted samples of the current block and/or the neighboring reconstructed or predicted samples of the collocated color-component block of the current block and/or the neighboring reconstructed or predicted samples of the collocated color-component block of the template of the current block and/or the neighboring reconstructed or predicted samples of the template of the current block. For example, when generating the predictor of the current block, the candidate intra prediction mode uses the neighboring reconstructed or predicted samples of the current block and/or the neighboring reconstructed or predicted samples of the collocated color-component block of the current block and/or the current reconstructed or predicted samples of the collocated color-component block of the current block and/or the current predicted samples of the current block. When the current block corresponds to chroma component such as Cb and/or Cr, the collocated color-component block of the current block corresponds to a collocated luma block which is located using the position of the current block and/or downsampled as the size of the current block. When generating the to-be-predicted sample at position (x, y) of the current block, the to-be-used samples are determined using the position.

In some embodiments of the intra prediction mode implicitly derived from the MPM list, for each intra prediction mode in the MPM list, the Sum of Absolute Transformed Difference (SATD) (or any pre-defined measurement such as Sum of Absolute Difference (SAD)) between the predicted and reconstructed samples of the template is calculated as the template matching (TM) cost of the intra prediction mode. First two intra prediction modes with the minimum SATD are selected as the TEVID modes. These two TEVID modes are fused with the weights after applying PDPC process if PDPC is determined to be applied, and such weighted intra prediction is used to code the current CU. In response to applying PDPC, Position dependent intra prediction combination (PDPC) is included in the template-based derivation of the TIMID modes.

The costs of two selected modes (model and mode2) are compared with a threshold, in the test the cost factor of 2 is applied as follows:

$$costMode 2 < 2 * costMode 1$$

If this condition is true, the prediction fusion is applied, otherwise only model is used. Weights of the modes are computed from their SATD costs as follows:

$$weight 1 = costMode 2 / ( costMode 1 + costMode 2 )$$

$$weight 2 = 1 - weight 1$$

### IV. Cross Component Prediction Generated Using One or More of Following Intra Prediction Modes

a. Cross Component Linear Model (CCLM)

Cross Component Linear Model (CCLM) or Linear Model (LM) mode is a cross component prediction mode in which chroma components of a block is predicted from the collocated reconstructed luma samples by linear models. The parameters (e.g., scale and offset) of the linear model are derived from already reconstructed luma and chroma samples that are adjacent to the block. For example, in VVC, the CCLM mode makes use of inter-channel dependencies to predict the chroma samples from reconstructed luma samples. This prediction is carried out using a linear model in the form of:

$$P ( i , j ) = α \cdot {rec}_{L}^{′} ( i , j ) + β \qquad ( 1 )$$

P(i,j) in eq. (1) represents the predicted chroma samples in a CU (or the predicted chroma samples of the current CU) and

$${rec}_{L}^{′} ( i , j )$$

represents the down-sampled reconstructed luma samples of the same CU (or the corresponding reconstructed luma samples of the current CU).

The CCLM model parameters α (scaling parameter) and R (offset parameter) are derived based on at most four neighboring chroma samples and their corresponding down-sampled luma samples. In LM_A mode (also denoted as LM-T mode), only the above or top-neighboring template is used to calculate the linear model coefficients. In LM_L mode (also denoted as LM-L mode), only left template is used to calculate the linear model coefficients. In LM-LA mode (also denoted as LM-LT mode), both left and above templates are used to calculate the linear model coefficients (or parameters).

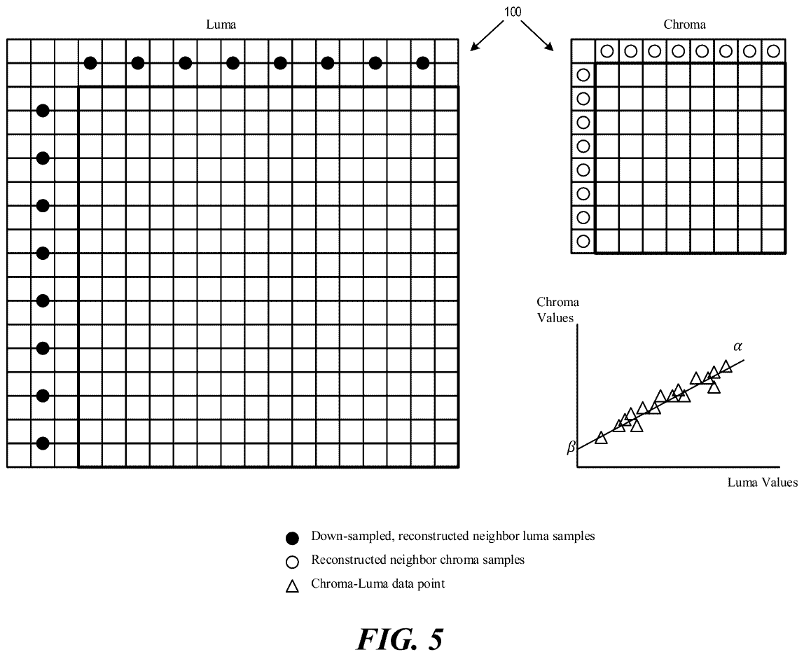

FIG. 5 conceptually illustrates chroma and luma samples that are used for derivation of linear model parameters. The figure illustrates a current block 100 having luma component samples and chroma component samples in 4:2:0 format. The luma and chroma samples neighboring the current block are reconstructed samples. These reconstructed samples are used to derive the cross-component linear model (parameters α and β). Since the current block in 4:2:0 format, the luma samples are down-sampled first before being used for linear model derivation. In the example, there are 16 pairs of reconstructed luma (down-sampled) and chroma samples neighboring the current block. These 16 pairs of luma versus chroma values are used to derive the linear model parameters.

Suppose the current chroma block dimensions are WxH, then W′ and H′ are set as
W′=W, H′=H when LM-LT mode is applied;
W′=W+H when LM-T mode is applied;
H′=H+W when LM-L mode is applied

The above neighboring positions are denoted as S[0, −1] . . . S[W′− 1, −1] and the left neighboring positions are denoted as S[−1, 0] . . . S[−1, H′− 1]. Then the four samples are selected as
S[W′/4, −1], S[3*W′/4, −1], S[−1, H′/4], S[−1, 3*H′/4] when LM mode is applied (both above and left neighboring samples are available);
S[W′/8, −1], S[3*W′/8, −1], S[5*W′/8, −1], S[7*W′/8, −1] when LM-T mode is applied (only the above neighboring samples are available);
S[−1, H′/8], S[−1, 3*H′/8], S[−1, 5*H′/8], S[−1, 7*H′/8] when LM-L mode is applied (only the left neighboring samples are available);

The four neighboring luma samples at the selected positions are down-sampled and compared four times to find two larger values: X⁰_{A} and x¹_{A}, and two smaller values: X⁰_{B} and x¹_{B}. Their corresponding chroma sample values are denoted as y⁰_{A}, y¹_{A}, y⁰_{B} and y¹_{B}. Then X_{A}, X_{B}, Y_{A} and Y_{B} are derived as:

$${X}_{a} = ( {x}_{A}^{0} + {x}_{A}^{1} + 1 ) >> 1 ; {X}_{b} = ( {x}_{B}^{0} + {x}_{B}^{1} + 1 ) >> 1 ; \qquad ( 2 )$$

$${Y}_{a} = ( {y}_{A}^{0} + {y}_{A}^{1} + 1 ) >> 1 ; {Y}_{b} = ( {y}_{B}^{0} + {y}_{B}^{1} + 1 ) >> 1 \qquad ( 3 )$$

The linear model parameters α and β are obtained according to the following equations

$$α = \frac{{Y}_{a} - {Y}_{b}}{{X}_{a} - {X}_{b}} \qquad ( 4 )$$

$$β = {y}_{b} - α {X}_{b} \qquad ( 5 )$$

The operations to calculate the α and β parameters according to eq. (4) and (5) may be implemented by a look-up table. In some embodiments, to reduce the memory required for storing the look-up table, the diff value (difference between maximum and minimum values) and the parameter a are expressed by an exponential notation. For example, diffis approximated with a 4-bit significant part and an exponent. Consequently, the table for 1/diff is reduced to 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 6 )$$

This reduces the complexity of the calculation as well as the memory size required for storing the needed tables.

In some embodiments, to get more samples for calculating the CCLM model parameters α and β, the above template is extended to contain (W+H) samples for LM-T mode, the left template is extended to contain (H+W) samples for LM-L mode. For LM-LT mode, both the extended left template and the extended above templates are used to calculate the linear model coefficients.

In some embodiments, to match the chroma sample locations for 4:2:0 video sequences, two types of down-sampling filters are applied to luma samples to achieve 2 to 1 down-sampling ratio in both horizontal and vertical directions. The selection of down-sampling filter is specified by a sequence parameter set (SPS) level flag. The two down-sampling filters are as follows, which correspond to “type-0” and “type-2” content, respectively.

$${rec}_{L}^{′} ( i , j ) = [ {rec}_{L} ( 2 i - 1 , 2 j - 1 ) + 2 * {rec}_{L} ( 2 i - 1 , 2 j - 1 ) + {rec}_{L} ( 2 i + 1 , 2 j - 1 ) + {rec}_{L} ( 2 i - 1 , 2 j ) + 2 * {rec}_{L} ( 2 i , 2 j ) + {rec}_{L} ( 2 i + 1 , 2 j ) + 4 ] >> 3 \qquad ( 7 )$$

$${rec}_{L}^{′} ( i , j ) = [ {rec}_{L} ( 2 i , 2 j - 1 ) + {rec}_{L} ( 2 i - 1 , 2 j ) + 4 * {rec}_{L} ( 2 i , 2 j ) + {rec}_{L} ( 2 i + 1 , 2 j ) + {rec}_{L} ( 2 i , 2 j + 1 ) + 4 ] >> 3 \qquad ( 8 )$$

In some embodiments, only one luma line (general line buffer in intra prediction) is used to make the down-sampled luma samples when the upper reference line is at the CTU boundary.

In some embodiments, the α and β parameters computation is performed as part of the decoding process, and is not just as an encoder search operation. As a result, no syntax is used to convey the α and β values to decoder.

For chroma intra mode coding, a total of 8 or more of 8 or any subset of 8 intra prediction modes are allowed. Those modes include five traditional intra prediction modes and three cross-component linear model modes (LM_LA, LM_A, and LM_L). Chroma intra mode coding may directly depend on the intra prediction mode of the corresponding luma block. For example, chroma intra mode signaling and corresponding luma intra prediction modes are according to the following table:

TABLE 2

| | |
|---|---|
| Chroma Intra | Corresponding Luma Intra Prediction |
| Prediction | Mode |

| Mode | 0 | 50 | 18 | 1 | X (0 ≤ X ≤ 66) |
|---|---|---|---|---|---|
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

Since separate block partitioning structure for luma and chroma components is enabled in I slices, one chroma block may correspond to multiple luma blocks. Therefore, for chroma derived mode (DM) mode, the intra prediction mode of the corresponding luma block covering the center position of the current chroma block is directly inherited.

For an example of chroma intra mode coding using a total of 8 intra prediction modes, a single unified binarization table (mapping to bin string) is used for chroma intra prediction mode according to the following table:

TABLE 3

| Chroma intra | |
|---|---|
| prediction mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In the Table, the first bin indicates whether it is regular (0) or LM mode (1). If it is LM mode, then the next bin indicates whether it is LM_CHROMA (LM_LA) (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in the table are context coded with its own context model, and the rest bins are bypass coded.

In some embodiments, in order to reduce luma-chroma latency in dual tree, when the 64×64 luma coding tree node is not split (and ISP is not used for the 64×64 CU) or partitioned with QT, the chroma CUs in 32×32/32×16 chroma coding tree node are allowed to use CCLM in the following way:
If the 32×32 chroma node is not split or partitioned with QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.
In all the other luma and chroma coding tree split conditions, CCLM is not allowed for chroma CU.
   b. Multi-Model CCLM (MMLM)

Multiple model CCLM mode (MMLM) uses two models for predicting the chroma samples from the luma samples for the whole CU. Similar to CCLM, three multiple model CCLM modes (MMLM_LA, MMLM_A, and MMLM_L) are used to indicate if both above and left neighboring samples, only above neighboring samples, or only left neighboring samples are used in model parameters derivation.

In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples.

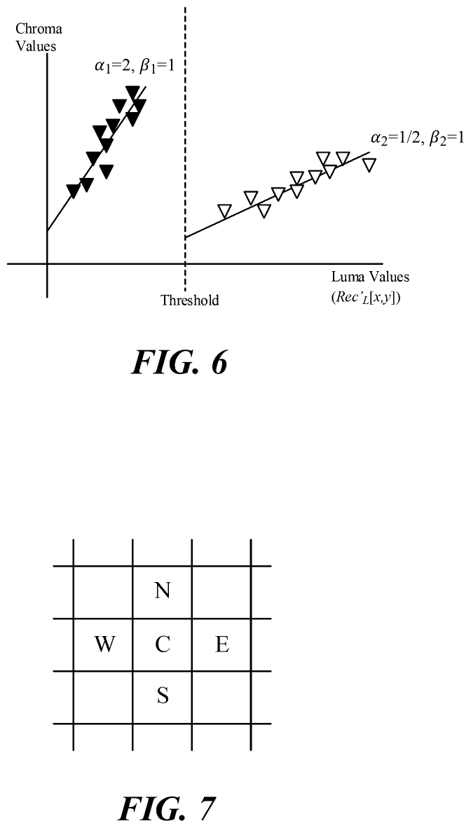

FIG. 6 shows an example of classifying the neighbouring samples into two groups.

Threshold is calculated as the average or mean value of the neighbouring reconstructed luma samples. A neighbouring sample at [x,y] with Rec′_{L}[x, y]<=Threshold is classified into group 1; while a neighbouring sample at [x,y] with Rec′_{L}[x, y](or rec_{L}′(x, y))>Threshold is classified into group 2. Thus, the multi-model CCLM prediction for the chroma samples is:

$${Pred}_{c} [ x , y ] = {α}_{1} \times {Rec}_{L}^{′} [ x , y ] + {β}_{1} if {Rec}_{L}^{′} [ x , y ] \leq Threshold$$

$${Pred}_{c} [ x , y ] = {α}_{2} \times {Rec}_{L}^{′} [ x , y ] + {β}_{2} if {Rec}_{L}^{′} [ x , y ] > Threshold$$

c. Convolutional Cross-Component Model

In some embodiments, a convolutional cross-component model (CCCM) is applied to improve the cross-component prediction performance. For some embodiment, the convolutional model has 7-tap filter having a 5-tap plus sign shape spatial component, a non-linear term and a bias term. The input to the spatial 5-tap component of the filter includes a center (C) luma sample which is collocated with the chroma sample to be predicted and its above/north (N), below/south (S), left/west (W) and right/east (E) neighbors. FIG. 7 conceptually illustrates the spatial components of a convolutional filter. The non-linear term (denoted as P) is represented as power of two of the center luma sample C and scaled to the sample value range of the content:

$$P = ( C * C + midVal ) >> bitDepth \qquad ( 9 )$$

Thus, for 10-bit content the non-linear term P is calculated as:

$$P = ( C * C + 5 \; 12 ) >> 10$$

The bias term (denoted as B) represents a scalar offset between the input and output (similarly to the offset term in CCLM) and is set to middle chroma value (512 for 10-bit content). Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B \qquad ( 10 )$$

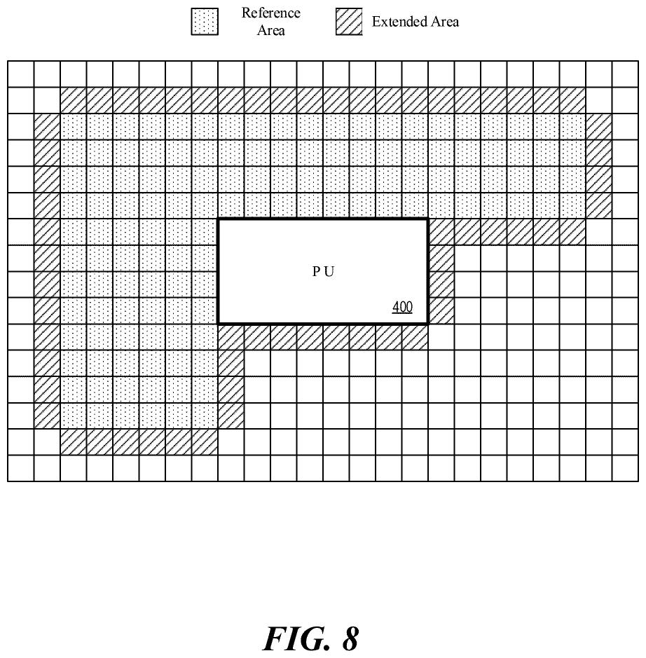

The filter coefficients ci are calculated by minimising MSE or any distortion between predicted and reconstructed chroma samples in a reference area by using a pre-defined regression method such as gaussian elimination. FIG. 8 illustrates a example of the reference area that is used to derive filter coefficients for a convolution model for a current block. The reference area includes (reference) lines of (chroma) samples above and left of the current block 400. (The current block 400 is a PU in this example). The reference area extends one PU width to the right and one PU height below the PU boundaries. Area is adjusted to include only available samples. An extension area to the reference area is used to support the “side samples” of the plus shaped spatial filter and are padded when in unavailable areas.

The MSE minimization is performed by calculating an autocorrelation matrix for the luma input and a cross-correlation vector between the luma input and chroma output. The autocorrelation matrix is LDL decomposed or gaussian elimination and the final filter coefficients (or model parameters) are calculated using back-substitution. The process is similar to the calculation of the ALF filter coefficients in ECM, however, in some embodiments, LDL decomposition or gaussian elimination was chosen instead of Cholesky decomposition to avoid using square root operations.

### V. Intra Block Copy (IBC) Mode

Intra Block Copy (IBC) is also referred to as Current Picture Referencing (CPR). An IBC (or CPR) motion vector is one that refers to the already-reconstructed reference samples in the current picture. For some embodiments, IBC prediction mode is treated as the third prediction mode other than intra or inter prediction modes for coding a CU.

Since IBC mode is implemented as a block level coding mode, block matching (BM) and/or template matching is performed at the encoder to find the optimal block vector (or motion vector) for each CU. Here, a block vector (BV) is used to indicate the displacement from the current block to a reference block, which is already reconstructed inside the current picture. In some embodiments, the luma block vector of an IBC-coded CU is in integer precision.

### VI. Combined Inter and Intra Prediction (CIIP)

The Combined inter and intra prediction (CIIP) combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode or the one or more intra prediction modes derived from a pre-defined mechanism. For example, in the following, the pre-defined mechanism is based on the neighboring reference regions (template) of the current block. The intra prediction mode of a CU is implicitly derived by a neighboring template at both encoder and decoder, instead of being signalled as the exact intra prediction mode bits to the decoder. For example, the intra prediction mode is implicitly derived using TIMD, and/or DIMD, and/or any variations in TIMD and/or DIMD. For an example of using one kind of TIMD, the prediction samples of the template are generated using the reference samples of the template for each candidate mode. A cost is calculated as the SATD between the prediction and the reconstruction samples of the template. The intra prediction mode with the minimum cost and/or some intra prediction modes with the smaller costs are selected and used for intra prediction of the CU. The candidate modes may be all MPMs and/or any subset of MPMs, 67 intra prediction modes as in VVC or extended to 131 intra prediction modes. The intra and inter prediction signals are combined using weighted averaging, where the weight value is calculated depending on the coding modes of the top and left neighbouring blocks. The CIIP prediction P_{CIIP} is formed as follows: (wt is the weight value)

$${P}_{CIIP} = ( ( 4 - wt ) * {P}_{inter} + wt * {P}_{intra} + 2 ) >> 2$$

In some embodiments, when a CU is coded in merge mode, if the CU contains at least 64 luma samples (that is, CU width times CU height is equal to or larger than 64), and if both CU width and CU height are less than 128 luma samples, an additional flag maybe signaled to indicate if CIIP mode is applied to the current CU.

### VII. Matrix-Weighted Intra Prediction (MIP)

Matrix weighted intra prediction (MIP) method is an intra prediction technique. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps: averaging, matrix vector multiplication, and linear interpolation.

Among the boundary samples, a pre-defined samples (for example, four samples or eight samples) are selected by averaging based on block size and shape. Specifically, the input boundaries bdry^{top} and bdry^{left} are reduced to smaller boundaries

$${bdry}_{red}^{top} and {bdry}_{red}^{left}$$

by averaging neighboring boundary samples according to predefined rule depends on block size. Then, in some embodiments, the two reduced boundaries

$${bdry}_{red}^{top} and {bdry}_{red}^{left}$$

are concatenated to a reduced boundary vector bdry_{red} which is thus of size four for blocks of shape 4×4 and of size eight for blocks of all other shapes. If mode refers to the MIP-mode, this concatenation is defined as follows:

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6\end{matrix} .$$

In some embodiments, a matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the downsampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix}$$

$${H}_{red} = \{ \begin{matrix}4 & for max ( W , H ) \leq 8 \\ min ( H , 8 ) & for max ( W , H ) > 8\end{matrix}$$

The reduced prediction signal pred_{red} is computed by calculating a matrix vector product and adding an offset:

$${pred}_{red} = A \cdot {bdry}_{red} + b .$$

Here, A is a prediction matrix that has W_{red}·H_{red} rows and 4 columns if W=H=4 and 8 columns in all other cases. b is a vector of size W_{red}·H_{red}. The prediction matrix A and the offset vector b are taken from one of the sets S₀, S₁, S₂. For example, one defines an index idx=idx(W, H) as follows:

$$idx ( W , H ) = \{ \begin{matrix}0 & for W = H = 4 \\ 1 & for max ( W , H ) = 8 \\ 2 & for max ( W , H ) > 8\end{matrix} .$$

In some embodiments, each coefficient of the matrix A (prediction matrix) is represented with 8 bit precision. The set S₀ consists of 16 matrices

$${A}_{0}^{i} , i ∈ \{ 0 , … , 15 \}$$

each of which has 16 rows and 4 columns and 16 offset vectors

$${b}_{0}^{i} , i ∈ \{ 0 , … , 16 \}$$

each of size 16. Matrices and offset vectors of that set are used for blocks of size 4×4. The set S₁ consists of 8 matrices

$${A}_{1}^{i} , i ∈ \{ 0 , … , 7 \} ,$$

each of which has 16 rows and 8 columns and 8 offset vectors

$${b}_{1}^{i} , i ∈ \{ 0 , … , 7 \}$$

each of size 16. The set S₂ consists of 6 matrices

$${A}_{2}^{i} , i ∈ \{ 0 , … , 5 \} ,$$

each of which has 64 rows and 8 columns and of 6 offset vectors

$${b}_{2}^{i} , i ∈ \{ 0 , … , 5 \}$$

of size 64.

In some embodiments, the prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

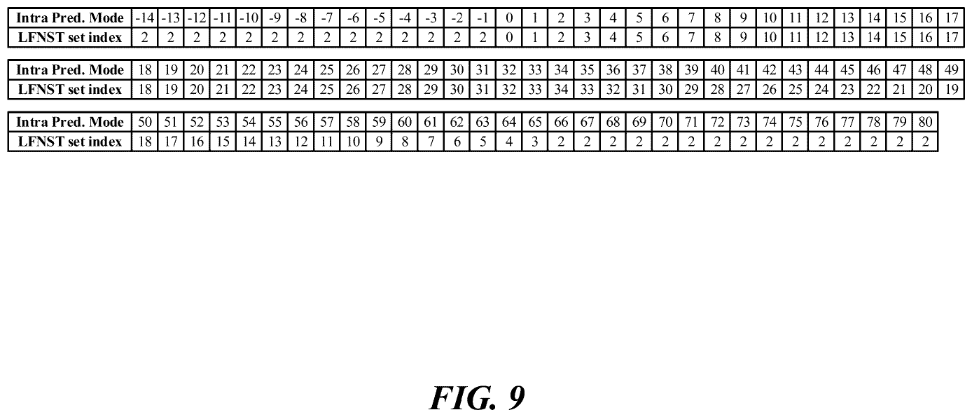

In some embodiments, the transform set and/or transpose flag of a pre-defined transform process are determined by the intra prediction mode predModeIntra of the current transform block. In one embodiment, the pre-defined transform process refers to non-separable transform of primary transform. In another embodiment, the pre-defined transform process refers to non-separable transform of secondary transform. For example, Low Frequency Non-Separable Transform (LFNST). In another embodiment, the pre-defined transform process refers to separable transform of primary transform. For example, DCT-II and/or any transform types in MTS. In another embodiment, the pre-defined transform process refers to separable transform of secondary transform. In some embodiments, with the predModeIntra, the following operation is conducted: (i) if the current block is MIP coded block, predModeIntra is mapped to PLANAR, and (ii) if the current block is CCLM coded block, predModeIntra is mapped to the co-located luma intra prediction mode. In some embodiments, predModeIntra is further derived from wide angle intra prediction mapping with a range of [−14, 83]. For an example of LFNST, selection of LFNST transform sets is from 35 transform sets and 3 non-separable transform matrices (kernels) per transform set in LFNST. The transform set index lfnstTrSetIdx is defined according to predModeIntra. FIG. 9 shows a table for LFNST transform set selection. The table maps different intra-prediction modes (or different predModeIntra) to different LFNST set indices.

In some embodiments, the LFNST transpose flag determines the scan order of the LFNST output (Decoder). The LFNST transpose flag is determined by predModeIntra as (i) if predModeIntra is less than or equal to 34, the LFNST transpose flag is set to 0 and (ii) else, the LFNST transpose flag is set to 1. In some embodiments, for MIP coded blocks, the predModeIntra is mapped to the PLANAR mode, the LFNST transform set 0 is used and LFNST transpose flag is always equal to 0. In some embodiments, LFNST is enabled for the MIP coded blocks with the width and height greater than or equal to 16.

Matrix-weighted intra prediction (MIP) takes one line of H reconstructed neighboring boundary samples left of the block and one line of W reconstructed neighboring boundary samples above the block as input. The generation of the prediction samples is based on the (i) boundary down-sampling, (ii) matrix vector multiplication, and (iii) MIP prediction up-sampling. Specifically, the video coder performing MIP first down-samples the reference samples, and then multiplies the down-sampled reference samples with the prediction matrix (matrix A) to generate partial prediction samples. The partial prediction samples is then up-sampled to generate the predicted samples at the remaining positions.

### VIII. Enhanced Multiple Transform Selection (MTS) for Intra Coding

In some embodiments, when performing Multiple Transform Selection (MTS) to transform residuals/inverse transform transformed coefficients of residuals as primary transform, only DST7 and DCT8 transform kernels are utilized, which are used for intra and/or inter coding. In some embodiments, additional primary transforms including DCT5, DST4, DST1, and identity transform (IDT) are also employed.

In some emodiments, MTS set is made dependent on the TU size and intra prediction mode information. In some embodiments, 16 different TU sizes are considered, and for each TU size 5 different classes are considered depending on intra-mode information. For each class, 1, 4 or 6 different transform pairs are considered. The number of intra MTS candidates may be adaptively selected (between 1, 4 and 6 MTS candidates) depending on the sum of absolute value of transform coefficients. The sum is compared against the two fixed thresholds (th0 and th1) to determine the total number of allowed MTS candidates. For example, 1 candidate: sum≤th0; 4 candidates: th0<sum≤th1, 6 candidates: sum>th1. Although a total of 80 different classes may be considered, some of those different classes often share exactly same transform set. So there may be 58 (less than 80) unique entries in the resultant look up table (LUT).

In some emodiments, for angular modes, a joint symmetry over TU shape and intra prediction is considered. So, a mode i (i>34) with TU shape A×B may be mapped to the same class corresponding to the mode j=(68−i) with TU shape BxA. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. In some emodiments, for the wide-angle intra modes the nearest conventional angular mode is used for the transform set determination. For example, mode 2 is used for all the modes between −2 and −14. Similarly, mode 66 is used for mode 67 to mode 80.

### IX. Template Matching Prediction (TMP)

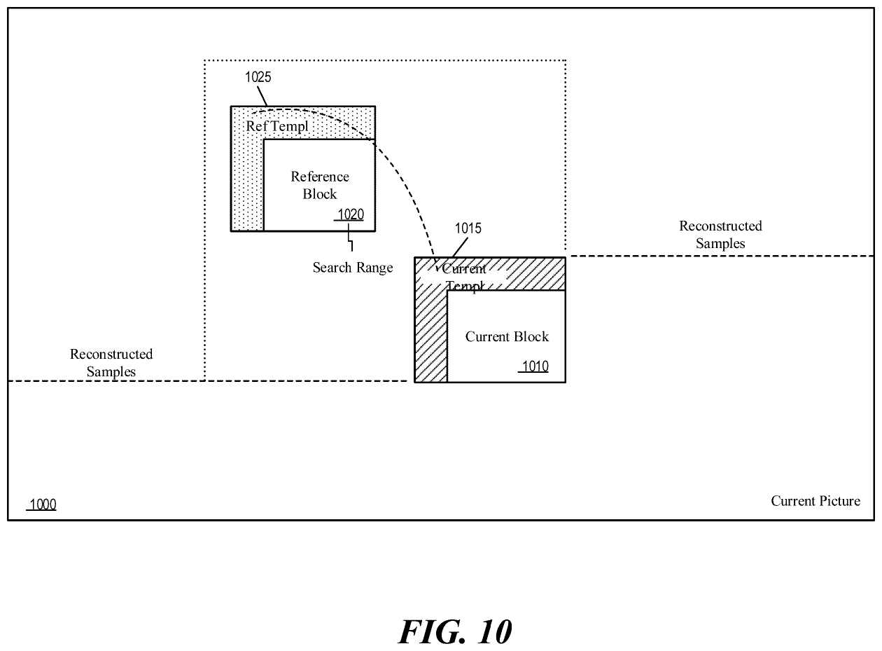

Template matching prediction (TMP), or intra TMP, is a special intra prediction mode that copies the best prediction block from the reconstructed part of the current frame. The best prediction block is one whose L-shaped (including above and left) template and/or above template only and/or left template only matches the current template. FIG. 10 conceptually illustrates template matching prediction (TMP). As illustrated, a current block 1010 in a current picture 1000 has a L-shaped neighboring region that is used as the current template 1015. For a predefined search range, the video encoder and/or decoder searches for the most similar template 1025 to the current template 1015 in the reconstructed part of the current frame, and uses the reconstructed samples of corresponding block 1020 as a prediction block/predictor for the current block. The encoder then signals the usage of this mode, and/or the signal is parsed at the decoder side.

### X. Representative Prediction Mode of the Current Block

Some embodiments of the disclosure provide a method of determining a representative prediction mode for a block a pixels. Such a block of pixels may be prediction-coded by regular intra mode, special intra mode, or non-intra mode.

Regular intra mode refers to using one or more traditional intra prediction modes and spatially neighboring reference samples (located in the adjacent or non-adjacent reference line for the current block) to generate the predictors for the current block. The regular intra mode may be used for luma and/or chroma components and the used traditional intra prediction modes may be indicated with syntax elements and/or a pre-defined implicit derivation method (such as DIMD and/or TIMD).

Special intra mode refers to applying an alternative scheme (such as a matrix-based scheme and/or cross-component information, instead of the traditional 67 or 131 intra prediction modes) to the spatially neighboring reference samples to generate the predictors for the current block. For example, the special intra mode may refer to Matrix-weighted Intra Prediction (MIP). The special intra mode may also be used for luma and/or chroma components. For example, the special intra mode may refer to any one of LM modes (such as CCLM and/or MMLM) and/or any one of LM variations (intra prediction modes for generating cross component prediction such as CCCM and/or Gradient Linear Model (GLM)), or TMP. When GLM is used for the current block, compared with the CCLM, instead of down-sampled luma values, the GLM utilizes luma sample gradients to derive the linear model. Therefore, if a cross-component model such as CCLM, CCCM, GLM and/or any model derived using cross-component correlation is used for the current block to predict chroma components, a representative prediction mode is needed for some encoding or decoding stages in some embodiments.

Non-intra mode may refer to IBC (intra block copy), inter mode, and/or any mode with mode type not equal to intra mode type (MODE_TYPE_INTRA). The non-intra mode may be used for luma and/or chroma components.

At the prediction stage, to improve prediction efficiency, the video coder may apply adjustment according to various prediction modes when generating predictors or after generating predictors for the current block. However, the encoding or decoding process of the current block may require one representative prediction mode for the current block, even when multiple different intra prediction modes were used to generate the predictor (e.g., regular intra prediction using multiple hypotheses based on multiple traditional intra-prediction mode), or no intra prediction mode was used to generate the predictor (e.g., special or non-intra prediction using no traditional intra-prediction mode).

In some embodiments, the video coder may use the one representative (intra-prediction) prediction mode of the current block for some encoding or decoding stages (which may be or not be after the prediction process). For example, for the transform/inverse transform stage of the current block, the video coder may use the one representative intra-prediction mode to select a transform set and/or a transpose flag for secondary transform (e.g., low frequency non-separable transform, or LFNST) or any pre-defined separable/non-separable and/or low-frequency/non-low-frequency transform. (For an encoder, the secondary transform is applied to the primary-transformed coefficients after the primary transform; for a decoder, the inverse secondary transform is applied to received-dequantized coefficients before the inverse primary transform.)

In some embodiments, for the transform/inverse transform stage, the video coder may use the one representative prediction mode to select the transform kernel for the primary transform (e.g., a default primary transform such as DCT-II, and/or MTS, and/or non-separable primary transform). The primary transform may be any pre-defined transform that is performed on residuals at the encoder or on inverse-secondary-transformed coefficients at the decoder.

In some embodiments, the one representative (intra-prediction) mode of the current block may be used for deriving a MPM list of a subsequent coding block. In other words, a coding block may use the intra prediction mode information (e.g., the one representative (intra-prediction) prediction mode) of a neighboring and/or subsequent coding block to derive a MPM list.

In some embodiments, if the current block is a luma block, the video coder may use the one representative prediction mode of the luma block to determine the chroma DM of a collocated chroma block. (In Chroma DM mode, the representative (intra) prediction mode of the corresponding (collocated) luma block covering the center position of the current chroma block is directly inherited by the chroma block.)

In some embodiments, the representative prediction mode of the current block may be pre-defined to be a DIMD derived mode (derived by applying histogram/gradient analysis on all or any subset of the predicted samples of the current block and/or derived by applying histogram/gradient analysis on all or any subset of the spatially neighboring reconstructed samples), a TIMD derived mode (derived by applying analysis on all or any subset of the predicted samples of the current block by comparing the distortions between the final predictor of the current block and the fake predictor of the current block generated using each candidate representative prediction mode and/or derived by applying template analysis on all or any subset of the spatially neighboring reconstructed samples by comparing the distortions between the reconstructed samples on the template and the predictor on the template generated using each candidate representative prediction mode), or any of DC, planar, horizontal, vertical, diagonal, or any pre-defined mode from the available intra prediction modes. For example, for a current block that is coded by MIP and the pre-defined intra prediction mode being a DIMD derived mode, the DIMD derived mode is stored as the representative prediction mode of the current block and/or can be used for coding subsequent blocks to e.g., derive the MPM list of a subsequent block, determine the intra prediction mode of a collocated chroma block (e.g., to derive chroma DM if the current block is luma), and/or select the transform set and/or transpose flag and/or transform kernel for the primary transform and/or secondary transform of the current block.

In some embodiments, the representative prediction mode is determined by applying a pre-defined process to all or any subset of the predicted samples of the current block. The video coder performing the pre-defined process may suggest an intra prediction mode as the representative prediction mode for the current block.

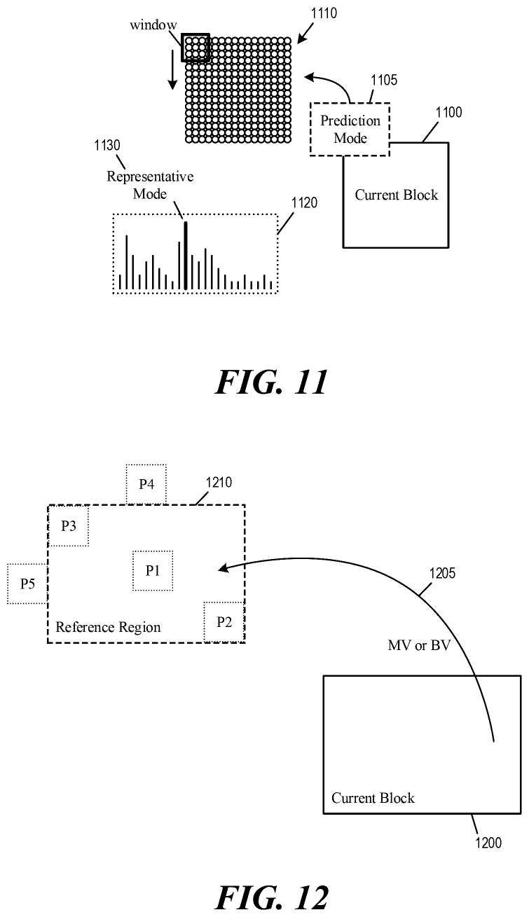

In some embodiments, the pre-defined process for determining the representative prediction mode refers to DIMD and/or TIMD. For some embodiments in which DIMD is used as the pre-defined process, a DIMD window is applied to the predictor of the current block. FIG. 11 conceptually illustrates using the predictor of the current block to determine the representative prediction mode for the current block. As illustrated, a current block 1100 is encoded and/or decoded by using a predictor 1110, which are prediction samples generated according to the current block's prediction mode 1105 (can be any prediction mode that is regular intra, special intra, or non-intra). A DIMD window is applied to the samples of the predictor 1110 to accumulate HoGs (histogram analysis) 1120, which is in turn used to identify an intra-prediction mode 1130 that is used as the representative prediction mode of the current block 1100.

In some of these embodiments, the predicted samples in the predictor 1110 are temporary predictor (for example, partial prediction samples in MIP) or first down-sampled predictor as the reduced predicted samples and the pre-defined process is applied to all or any subset of the reduced predicted samples. For example, the size of the current block can be down-sampled from 2M×2N to M×N. In some embodiments, when determining the representative prediction mode, the center of the DIMD window is applied to samples within the current block (or reduced current block) but not those located at the boundary of the current block. If the DEVID window requires any sample outside of the current (or reduced) block, padding from the boundary or only applying the DIMD window with the center position in the window is not at boundary is used instead of referencing the samples outside of the current (or reduced) block.

For example, for a current block coded by MIP and the representative prediction mode being from DID, the representative prediction mode may be stored for MIP and/or can be used for coding subsequent blocks to e.g., derive the MPM list of a subsequent block, determine the intra prediction mode of a collocated chroma block (e.g., to derive chroma DM if the current block is luma), and/or select the transform set and/or transpose flag and/or transform kernel for the primary transform and/or secondary transform of the current block.

In some embodiments, for each coding block (or any pre-defined coding unit) or for each valid coding block (or any pre-defined coding unit) which satisfies a pre-defined condition (for example, intra-coded or not-intra-coded or inter-coded or traditional-intra-prediction-mode-coded or not-traditional-intra-prediction-mode-coded), a representative prediction mode is derived by performing the pre-defined process (for example, any above-mentioned DIMD and/or TIMD derivation) on the reconstructed samples of the coding block or the valid coding block. The derived representative prediction mode here can be stored and/or referenced by one or more subsequent blocks (for example, MPM list construction and/or transform set selection and/or prediction generation of a subsequent block) and/or one or more collocated chroma blocks (for example, chroma DM of a collocated chroma block). In some embodiments, the mode information of a reference region of the current block is used to derive the representative prediction mode of the current block. Compared to performing texture analysis (DIMD or TEID) on the predictors within the current block or the spatially neighboring samples, using mode information of the reference region to derive the representative prediction mode of the current block has the advantage of being simpler and/or can output the derived representative prediction mode of the current block earlier without waiting for the prediction stage of the current block to know the to-be-used predicted or reconstructed samples.

In some embodiments, the mode information of the reference region used to derive the representative prediction mode of the current block may be mode information for any pre-defined subset of the prediction units in a reference region (e.g., a reference block and/or a neighboring template/region of the reference block) of the current block or a coding block or any-pre-defined region. The mode information may include mode types, intra prediction modes, motion information, block width, block height, block area, block shape, block ratio, residual information, transform information, partitioning information, and/or any subset/extension of the above. In some embodiments, if the video coder fails to determine a representative prediction mode from the predefined subset of the prediction units, a default prediction mode is used as the representative prediction mode for the current block. The default prediction mode can be any available intra prediction mode such as DC, planar, normal DIMD mode (which may be derived at decoder), DIMD derived mode and/or TIMD derived mode.

In some embodiments in which the current block is coded by IBC (intra block copy) mode, a reference block is indicated by a block vector (BV), and one or more mode information (e.g., intra prediction mode) saved by/for the reference block is used to derive the representative prediction mode for the current block. If the reference block is any one of special intra mode, and/or non-intra mode, a default intra prediction mode may be used as the representative prediction mode. Otherwise, the intra prediction mode for the reference block (e.g., the intra prediction mode used to generate the predictor of the reference block) is used as the representative prediction mode for the current block.

In some embodiments in which the current block is coded by IBC, one or more prediction units (may include the IBC reference block and/or one or more prediction units spatially adjacent/non-adjacent to the reference block) in the reference region are pre-defined and a scanning order is applied to the pre-defined prediction units.

FIG. 12 shows the pre-defined prediction units in a reference region that are used to derive the representative intra-prediction for the current block. As illustrated, the reference region 1210 is referenced by the current block 1200 using a block vector (BV) 1205. The figure illustrates several pre-defined prediction units that are labeled P1, P2, P3, P4, and P5 in the reference region 1210 or neighboring the reference region 1210.

The video coder may select an intra prediction mode among the prediction units. The prediction units P1 to P5 may be scanned/considered/examined according to a pre-defined order: P1, P2, P3, (P4, P5). P1 covers the middle position in the reference block. P2 covers the right-bottom position in the reference block. P3 covers the left-above position in the reference block. P4 covers a pre-defined position (e.g., middle position) above-outer neighboring the reference block. P5 covers a pre-defined position (e.g., middle position) left-outer neighboring the reference block. If the height of the block is greater than the width, P5 is checked prior to P4. Otherwise, P4 is checked before P5.

In some embodiments, the first pre-defined prediction unit in the scanning order to have an intra prediction mode provides the representative prediction mode for the current block. In some embodiments, an explicit index is signaled/parsed to indicate an intra prediction mode among the pre-defined prediction units as the representative prediction mode.

In some embodiments in which the current block is coded by IBC, one or more prediction units (may include the IBC reference block and/or one or more prediction units spatially adjacent/non-adjacent to the reference blocks) in the reference region are pre-defined and a voting method is applied to determine the representative prediction mode from among the pre-defined prediction units. In some of these embodiments, the most popular prediction mode is used as the representative prediction mode for the current block.

When a pre-defined prediction unit does not have a valid (intra) prediction mode, it is designated as an invalid prediction unit. The invalid prediction unit may be skipped, or a default prediction mode is designated as the prediction mode for the invalid prediction unit. In some embodiments, pre-defined prediction units using non-intra modes (e.g., IBC), intra TMP, inter prediction, and/or MIP modes are considered invalid prediction units.

In some embodiments, when the representative prediction mode (an intra prediction mode) is used to determine the transform set and/or transform kernel of MTS (multiple transform selection), the MTS may be implicit or explicit and the current block may be predicted by regular intra mode, special intra mode, and/or non-intra mode. Explicit MTS (such as Enhanced MTS for intra coding) refers to signaling an MTS index to identify one transform candidate (transform pair consisting of horizontal transform direction and vertical transform direction) from a selected MTS set. Implicit MTS refers to using an implicit mapping rule (not depending on the syntax elements) to determine the transform candidate. In some embodiments, for explicit MTS, the selection of the MTS set depends on the representative prediction mode; for implicit MTS, the transform candidate is decided based on the representative prediction mode according to a mapping rule.

Tables 4-6 below show example mapping rules that maps a representative prediction mode to horizontal and vertical transforms: (“Ang.”=Angular intra mode)

TABLE 4

| Intra prediction mode | Horizontal transform | Vertical transform |
|---|---|---|
| Planar | DST-VII | DST-VII |
| Ang. 31, 32, 34, 36, 37 | | |
| DC | DCT-II | DCT-II |
| Ang. 33, 35 | | |
| Ang. 2, 4, 6 . . . 28, 30 | DST-VII | DCT-II |
| Ang. 39, 41, 43 . . . 63, 65 | | |
| Ang. 3, 5, 7 . . . 27, 29 | DCT-II | DST-VII |
| Ang. 38, 40, 42 . . . 64, 66 | | |

TABLE 5

| Intra prediction | | |
|---|---|---|
| mode | Horizontal Transform | Vertical Transform |
| Even (2, 4, 6, . . . ) | DCT-VIII | DCT-II |
| Odd (1, 3, 5, . . . ) | DCT-II | DST-VII |

TABLE 6

| Intra prediction | | |
|---|---|---|
| mode | Horizontal Transform | Vertical Transform |
| Even (2, 4, 6, . . . ) | DCT-II | DCT-VIII |
| Odd (1, 3, 5, . . . ) | DST-VII | DCT-II |

In some embodiments, representative intra-prediction mode can be used for transform selection in color format 4:4:4. For example, MIP can be used for chroma when the color format is 4:4:4. For a chroma MIP block, the representative prediction mode can be used for secondary transform to select the transform set and/or transpose flag.

In some embodiments, the representative prediction mode is stored in a buffer for intra prediction mode when the current block is coded with a special intra mode. Any subsequent coding process may access the buffer to learn the representative prediction mode.

In some embodiments, the representative prediction mode may implicitly vary with the block width, block height, block area or vary according to an explicit rule stated in syntax element of e.g., a block, tile, slice, picture, SPS, or PPS, etc. In some embodiments, any proposed methods or any combinations of the proposed methods can be applied to any intra modes such as WAIP, intra angular modes, Intra sub-partitions (ISP), MIP, or any intra mode specified in the VVC or HEVC. When the current block uses ISP, that means the current block is divided vertically or horizontally into sub-partitions depending on the block size. For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode.

In some embodiments, to reduce latency when performing primary transform, a video encoder may determine and use the precise representative prediction mode of the current block for vertical transform only but not for horizontal transform, and/or a corresponding video decoder may determine and use the precise representative prediction mode of the current block for vertical inverse transform only but not for horizontal inverse transform. In some embodiments, for primary transform, a video encoder may determine and use the precise representative prediction mode of the current block for horizontal transform only but not for vertical transform, and/or a corresponding video decoder may determine and use the precise representative prediction mode of the current block for horizontal inverse transform only but not for vertical inverse transform. The precise representative prediction mode refers to DIMD derived mode and/or TIMD derived mode which use derivation/analysis on the (predicted) samples associated with the current block to determine the representative prediction mode of the current block instead of directly assigning a default intra prediction mode or a stored intra prediction mode (associated with the reference region) as the (simple) representative prediction mode of the current block. If the precise representative prediction mode is not used for the current block, the simple representative prediction mode is used instead.

In some embodiments, to reduce the latency, corresponding encoder and/or decoder may determine and use the precise representative prediction mode of the current block for determining the prediction mode for separable transform coding (e.g., primary transform) and but not for non-separable transform (e.g., secondary transform). In some embodiments, video coders do not use the precise representative prediction mode of the current block for determining the prediction mode for secondary transform and/or non-separable transform. The precise representative prediction mode refers to DIMD derived mode and/or TVIMD derived mode which use derivation/analysis on the (predicted) samples associated with the current block to determine the representative prediction mode of the current block instead of directly assigning a default intra prediction mode or a stored intra prediction mode (associated with the reference region) as the (simple) representative prediction mode of the current block. If the precise representative prediction mode is not used for the current block, the simple representative prediction mode is used instead.

In some embodiments, a video coder determines and use the precise representative prediction mode of the current block only when certain enabling conditions are satisfied. In some embodiments, the enabling conditions include a mode setting such that the video coder checks the mode setting before applying the representative prediction mode of the current block. For example, the simple representative prediction mode is used for the current block instead of the precise representative prediction mode when the mode of the current block belongs to a complex mode. A complex mode may refer to a blending mode in which the final predictors is formed by multiple hypothesis of predictions. A blending mode may be a CIIP/GPM and/or any GPM extension and/or any GPM variations such as SGPM, Multi-hypothesis prediction (MHP), TIMD, and/or DIMD coded mode. For another example, the complex mode refers to a refining mode with the motion/predictors being refined by multiple passes or with decoder-side derivation. A refining mode may be a DMVR and/or intra TMP coded mode. When GPM is used for the current block, the current block is split into two geometric partitions by a geometrically located straight line (represented as a distance and an angle). Each geometric partition in the current block is inter-predicted using its own motion. An extension of GPM is that one geometric partition is intra-predicted. When SGPM is used for the current block, both geometric partitions are intra-predicted. When MHP is used for the current block, one or more additional motion-compensated prediction signals (in addition to the conventional bi prediction signal) is further added to form the resulting overall prediction signal. Therefore, for a blending mode, the final prediction is formed by combining multiple hypotheses of predictions and is complex. The precise representative prediction mode refers to DIMD derived mode and/or TIMID derived mode which uses derivation/analysis on the (predicted) samples associated with the current block to determine the representative prediction mode of the current block instead of directly assigning a default intra prediction mode or a stored intra prediction mode (associated with the reference region) as the (simple) representative prediction mode of the current block.

In some embodiments, the enabling conditions include a size setting related to block width, block height, or block area, or block shape. A size setting may specify that the size of the current block is checked first, and that the precise representative prediction mode cannot be applied if the size of the current block does not satisfy the size setting. For example, when the width and/or height for the current block is larger than a pre-defined threshold, the video coder does not determine or use the precise representative prediction mode of the current block. For another example, when the width and/or height of the current block is smaller than a pre-defined threshold, the video coder does not determine or use the precise representative prediction mode of the current block. For another example, if the area of the current block is larger than a pre-defined threshold, the video coder does not determine or use the precise representative prediction mode of the current block. For another example, if the area of the current block is smaller than a pre-defined threshold, the video coder does not determine or use the precise representative prediction mode of the current block. For another example, if the longer side of the current block is much larger than the shorter side of the current block, the video coder does not determine or use the precise representative prediction mode of the current block. The pre-defined threshold can be any integer such as 2, 4, 8, 16, . . . . The precise representative prediction mode refers to DIMD derived mode and/or TIMD derived mode which use derivation/analysis on the (predicted) samples associated with the current block to determine the representative prediction mode of the current block instead of directly assigning a default intra prediction mode or a stored intra prediction mode (associated with the reference region) as the (simple) representative prediction mode of the current block. If the precise representative prediction mode is not used for the current block, the simple representative prediction mode is used instead.

In some embodiments, to reduce the latency caused by determining the representative prediction mode of the current block, some pre-processing operations are performed prior to determining the representative prediction mode. In some embodiments, the pre-processing operations include checking a block setting. The block setting may refer to sub-sampling (e.g., down-sampling) the used predicted/reconstructed samples (within the current block and/or the spatially neighboring region of the current block and/or the reference region for the current block) first and then determine the representative prediction mode of the current block based on the sub-sampled samples. For another example, the block setting may refer to determining the representative prediction mode of the current block based on only a subset of the used predicted/reconstructed samples (within the current block and/or the spatially neighboring region of the current block and/or the reference region for the current block). The subset of the used samples may be the first N rows or cols of the used samples, where N can be any pre-defined integer such as 4, 8, 16, etc. The subset may be the first M samples in the used samples, where M can be any pre-defined integer such as 4, 8, 16, etc.

In some embodiments, the pre-processing operations include a splitting setting. The splitting setting refers to dividing the used predicted/reconstructed samples (within the current block and/or the spatially neighboring region of the current block and/or the reference region for the current block) into K subblocks and the representative prediction mode is determined and/or used for each subblock individually. (K can be any pre-defined integer such as 4, 16, . . . )

The proposed methods in this invention can be enabled and/or disabled according to implicit rules (e.g. block width, height, or area) or according to explicit rules (e.g., syntax on block, tile, slice, picture, SPS, or PPS level). For example, determining and using representative prediction mode of the current block is applied when the block area is smaller/larger than a threshold. The term “block” in this invention can refer to TU/TB, CU/CB, PU/PB, pre-defined region, or CTU/CTB. Any combination of the proposed methods in this invention can be applied.

Any of the foregoing proposed methods can be implemented in encoders and/or decoders. For example, any of the proposed methods can be implemented in an inter/intra/IBC/prediction/transform module of an encoder, and/or an inter/intra/IBC/prediction/transform module of a decoder. Alternatively, any of the proposed methods can be implemented as a circuit coupled to the inter/intra/IBC/prediction/transform module of the encoder and/or the inter/intra/IBC/prediction/transform module of the decoder, so as to provide the information needed by the inter/intra/IBC/prediction/transform module.

IBC coded blocks are used as example current blocks for some embodiments described above. However, the proposed methods of determining and using representative prediction mode of a current block are not limited to IBC blocks and can be used for the current block coded by any other mode (e.g., intra TMP or inter block). When the current block is coded with intra TMP, the reference block may be found by template matching.

In some embodiments, when the current block is coded with inter prediction mode, the reference block may be in a reference picture (a previously coded picture that is different from the current picture), which is indicated with motion information of the current block and. For example, the motion information for the current block may be bi-prediction, and the reference picture indicated by the reference index for list-0 and/or the reference picture indicated by the reference index for list-1 may be used. For another example, the motion information for the current block may be uni-prediction, and the reference picture indicated by the reference index may be either list-0 or list-1. If more than one reference pictures are used, an order may be used to define which reference picture is used first. One possible order is that the reference picture closer to the current picture (smaller POC) is used first. Another possible order is that the reference picture from a pre-defined list (list-0 or list-1) is used first.

### XI. Example Video Encoder

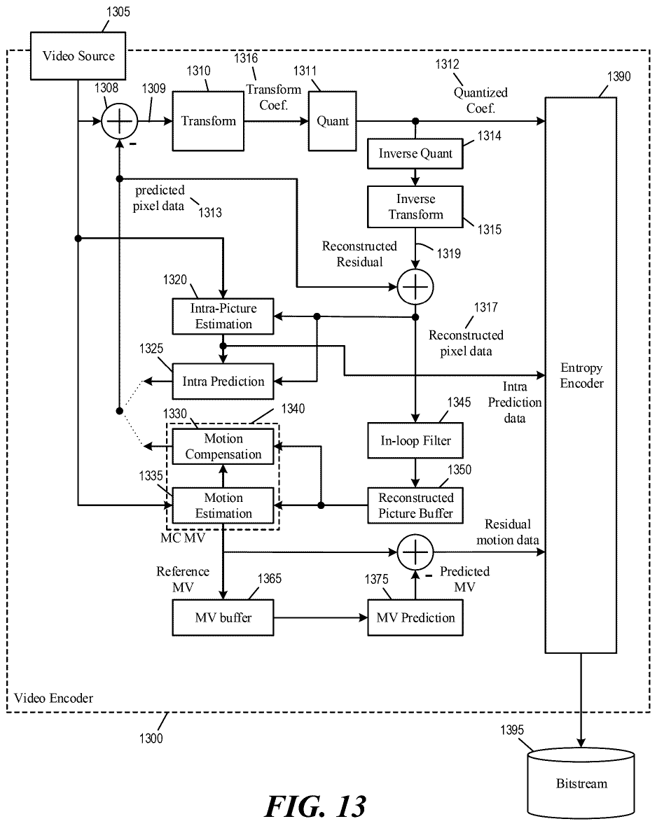

FIG. 13 illustrates an example video encoder 1300 may implement representative prediction modes for blocks of pixels being encoded. As illustrated, the video encoder 1300 receives input video signal from a video source 1305 and encodes the signal into bitstream 1395. The video encoder 1300 has several components or modules for encoding the signal from the video source 1305, at least including some components selected from a transform module 1310, a quantization module 1311, an inverse quantization module 1314, an inverse transform module 1315, an intra-picture estimation module 1320, an intra-prediction module 1325, a motion compensation module 1330, a motion estimation module 1335, an in-loop filter 1345, a reconstructed picture buffer 1350, a MV buffer 1365, and a MV prediction module 1375, and an entropy encoder 1390. The motion compensation module 1330 and the motion estimation module 1335 are part of an non-intra-prediction module 1340.

In some embodiments, the modules 1310-1390 are modules of software instructions being executed by one or more processing units (e.g., a processor) of a computing device or electronic apparatus. In some embodiments, the modules 1310-1390 are modules of hardware circuits implemented by one or more integrated circuits (ICs) of an electronic apparatus. Though the modules 1310-1390 are illustrated as being separate modules, some of the modules can be combined into a single module.

The video source 1305 provides a raw video signal that presents pixel data of each video frame without compression. A subtractor 1308 computes the difference between the raw video pixel data of the video source 1305 and the predicted pixel data 1313 from the motion compensation module 1330 or intra-prediction module 1325 as prediction residual 1309. The transform module 1310 converts the difference (or the residual pixel data or residual signal 1308) into transform coefficients (e.g., by performing Discrete Cosine Transform, or DCT). The quantization module 1311 quantizes the transform coefficients into quantized data (or quantized coefficients) 1312, which is encoded into the bitstream 1395 by the entropy encoder 1390.

The inverse quantization module 1314 de-quantizes the quantized data (or quantized coefficients) 1312 to obtain transform coefficients, and the inverse transform module 1315 performs inverse transform on the transform coefficients to produce reconstructed residual 1319. The reconstructed residual 1319 is added with the predicted pixel data 1313 to produce reconstructed pixel data 1317. In some embodiments, the reconstructed pixel data 1317 is temporarily stored in a line buffer (not illustrated) for intra-picture prediction and spatial MV prediction. The reconstructed pixels are filtered by the in-loop filter 1345 and stored in the reconstructed picture buffer 1350. In some embodiments, the reconstructed picture buffer 1350 is a storage external to the video encoder 1300. In some embodiments, the reconstructed picture buffer 1350 is a storage internal to the video encoder 1300.

The intra-picture estimation module 1320 performs intra-prediction based on the reconstructed pixel data 1317 to produce intra prediction data. The intra-prediction data is provided to the entropy encoder 1390 to be encoded into bitstream 1395. The intra-prediction data is also used by the intra-prediction module 1325 to produce the predicted pixel data 1313.

The motion estimation module 1335 performs inter-prediction by producing MVs to reference pixel data of previously decoded frames stored in the reconstructed picture buffer 1350. These MVs are provided to the motion compensation module 1330 to produce predicted pixel data.

Instead of encoding the complete actual MVs in the bitstream, the video encoder 1300 uses MV prediction to generate predicted MVs, and the difference between the MVs used for motion compensation and the predicted MVs is encoded as residual motion data and stored in the bitstream 1395.

The MV prediction module 1375 generates the predicted MVs based on reference MVs that were generated for encoding previously video frames, i.e., the motion compensation MVs that were used to perform motion compensation. The MV prediction module 1375 retrieves reference MVs from previous video frames from the MV buffer 1365. The video encoder 1300 stores the MVs generated for the current video frame in the MV buffer 1365 as reference MVs for generating predicted MVs.

The MV prediction module 1375 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1395 by the entropy encoder 1390.

The entropy encoder 1390 encodes various parameters and data into the bitstream 1395 by using entropy-coding techniques such as context-adaptive binary arithmetic coding (CABAC) or Huffman encoding. The entropy encoder 1390 encodes various header elements, flags, along with the quantized transform coefficients 1312, and the residual motion data as syntax elements into the bitstream 1395. The bitstream 1395 is in turn stored in a storage device or transmitted to a decoder over a communications medium such as a network.

The in-loop filter 1345 performs filtering or smoothing operations on the reconstructed pixel data 1317 to reduce the artifacts of coding, particularly at boundaries of pixel blocks. In some embodiments, the filtering or smoothing operations performed by the in-loop filter 1345 include deblock filter (DBF), sample adaptive offset (SAO), and/or adaptive loop filter (ALF).

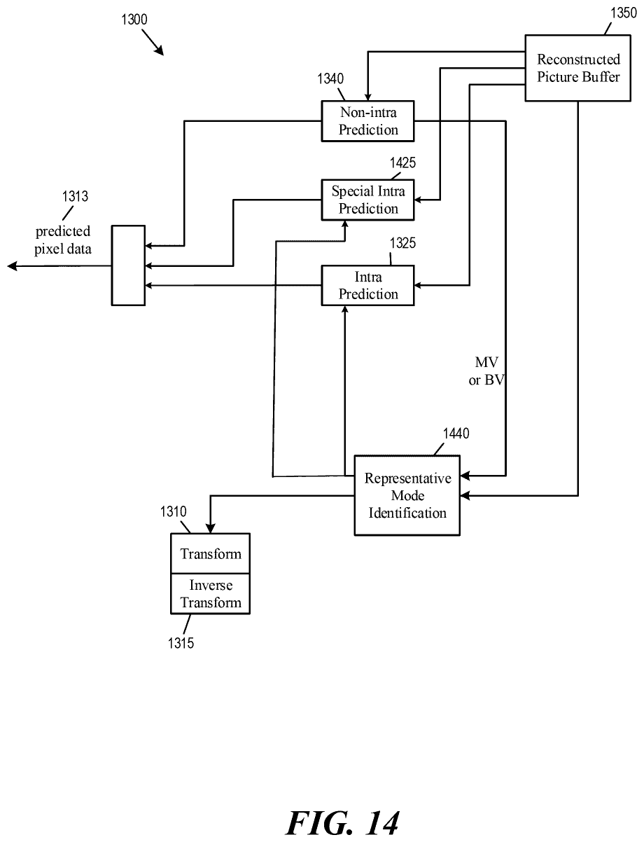

FIG. 14 illustrates portions of the video encoder 1300 that implement the representative prediction mode. As illustrated, the non-intra-prediction module (for example, inter-prediction module) 1340, the intra-prediction module 1325, and a special intra-prediction module 1425 retrieves pixel samples from the reconstructed picture buffer 1350 to produce the predictor of the current block in the predicted pixel data 1313. In some embodiments, the intra-prediction module 1325 performs prediction for regular intra modes, where DIMD or TIMD operations may be performed to select one or more intra-prediction directions.

The non-intra-prediction module 1340 performs motion estimation and compensation for inter prediction modes (e.g., merge modes). In some embodiments, the non-intra-prediction module 1340 also performs prediction based on samples in the current picture as reference, such as in IBC mode. More generally, the non-intra-prediction module 1340 performs prediction for non-intra modes.

Special intra-prediction module 1425 performs prediction for special intra modes, such as MIP, CCLM, blending mode, TMP modes, or other modes that uses samples of the current picture, as reference to generate the predictor of the current block without using the traditional 67 or 131 directional intra prediction modes, whether for the same component or different component.

The video encoder 1300 also includes a representative mode module 1440. The representative mode module 1440 generates or identifies a representative intra-prediction mode for the current block by selecting from a plurality of intra prediction modes based on costs/derivation/analysis, or by searching a plurality of predefined positions within or neighboring a reference region that is identified by a block vector or motion vector (provided by the non-intra-prediction module 1340).

The representative intra-prediction mode is provided to the transform module 1310 and the inverse transform module 1315 to select a transform mode. In some embodiments, the representative intra-prediction mode is used to select a primary transform (e.g., MTS) according to Tables 4-6. In some embodiments, the representative prediction mode is used to select a secondary transform (e.g., LFNST) according to FIG. 9. The representative intra-prediction mode is also stored in a storage buffer 1445 so the representative mode may or may not be used for coding a subsequent block as a most probable mode (MPM) and/or prediction generation and/or transform selection, or for coding a collocated chroma component block in chroma DM mode.

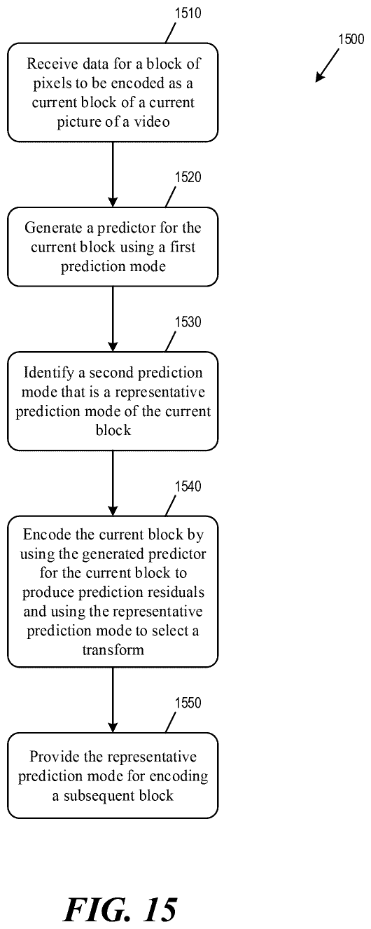

FIG. 15 conceptually illustrates a process 1500 for generating and using representative intra prediction of the current block. In some embodiments, one or more processing units (e.g., a processor) of a computing device implementing the encoder 1300 performs the process 1500 by executing instructions stored in a computer readable medium. In some embodiments, an electronic apparatus implementing the encoder 1300 performs the process 1500.

The encoder receives (at block 1510) data to be encoded as a current block of pixels in a current picture.

The encoder generates (at block 1520) a predictor for the current block using a first prediction mode. In some embodiments, the first prediction mode is not a directional intra-prediction mode. The first prediction mode may be a regular intra mode, special intra mode, and or non-intra mode. The encoder identifies (at block 1530) a second prediction mode as a representative prediction mode of the current block.

In some embodiments, the predictor is generated under MIP mode, i.e., by matrix multiplication of a pre-defined or derived matrix with a set of input samples derived (e.g., down-sampled) from samples neighboring the current block. In some embodiments, the current block is a chroma component block and the predictor for the current block is generated by applying a cross-component model to a collocated luma component block. In some embodiments, the predictor for the current block is generated by intraTMP mode based on a reference block that is identified by matching a first template region neighboring the current block with a second template region in the current picture or in a reference picture. In some embodiments, the predictor is generated under blending mode (for example, CIIP) by combining predictions from multiple prediction hypotheses.

In some embodiments, the predictor is generated by using a block vector or a motion vector to identify a reference region in the current picture or in a reference picture and the representative prediction mode is an intra prediction mode used to code pixel samples within or neighboring the reference region. In some embodiments, the encoder identifies the representative prediction mode by searching a plurality of predefined positions within or neighboring the reference region in a predefined order for determining the representative prediction mode.

In some embodiments, the representative prediction mode is selected from a plurality of intra prediction modes based on costs/derivation/analysis, where the cost of an intra prediction mode is a difference between reconstructed samples and predicted samples of a neighboring region for the current block and the predicted samples of the neighboring region for the current block is generated based on the intra prediction mode. In some embodiments, the representative prediction mode is identified by deriving a plurality of histograms of gradients (HoGs) for a plurality of intra prediction modes, and HoG for an intra prediction mode is derived based on a pre-defined set of the predictor for the current block.

The encoder encodes (at block 1540) the current block by using the generated predictor for the current block to produce prediction residuals and using the representative prediction mode to select a transform for the residual. In some embodiments, the representative intra-prediction mode is used to select a primary transform (e.g., MTS) according to Tables 4-6. In some embodiments, the representative intra-prediction mode is used to select a secondary transform (e.g., LFNST) according to FIG. 9. In some embodiments, the representative intra-prediction mode is used to select a transform set and/or a transpose flag for secondary transform.

The encoder stores the representative prediction mode of the current block and/or provides (at block 1550) the representative prediction mode for encoding a subsequent block. For example, in some embodiments, the encoder provides the representative prediction mode for use as a most probable mode (MPM), prediction generation, and/or transform selection for coding a subsequent block. In some embodiments, the current block is a luma component block and the representative prediction mode is used to encode a collocated chroma component block in chroma DM mode, by e.g., generating an intra prediction predictor of the chroma block.

### XI. Example Video Decoder

In some embodiments, an encoder may signal (or generate) one or more syntax element in a bitstream, such that a decoder may parse said one or more syntax element from the bitstream.

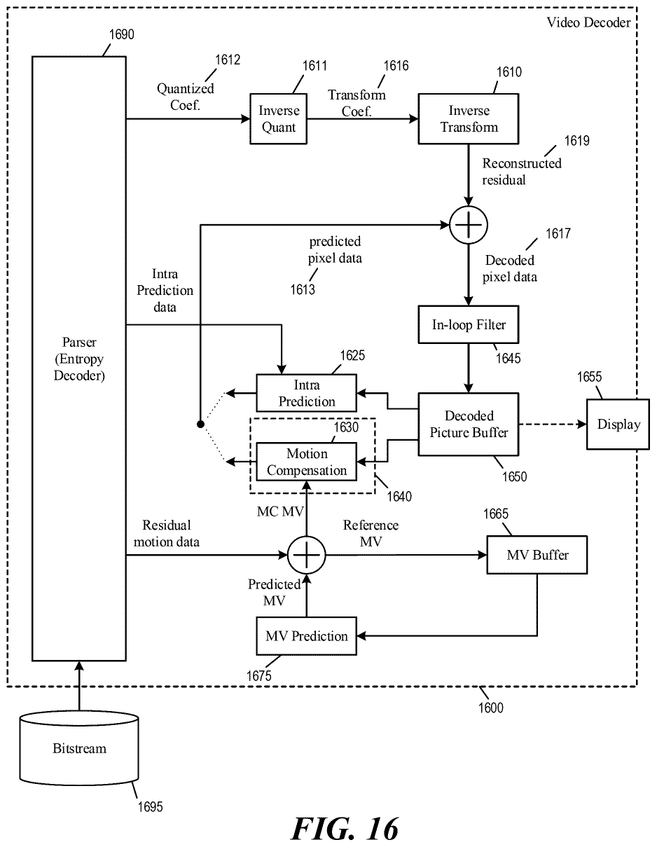

FIG. 16 illustrates an example video decoder 1600 may implement representative prediction modes for blocks of pixels being decoded. As illustrated, the video decoder 1600 is an image-decoding or video-decoding circuit that receives a bitstream 1695 and decodes the content of the bitstream into pixel data of video frames for display. The video decoder 1600 has several components or modules for decoding the bitstream 1695, including some components selected from an inverse quantization module 1611, an inverse transform module 1610, an intra-prediction module 1625, a motion compensation module 1630, an in-loop filter 1645, a decoded picture buffer 1650, a MV buffer 1665, a MV prediction module 1675, and a parser 1690. The motion compensation module 1630 is part of an non-intra-prediction module 1640.

In some embodiments, the modules 1610-1690 are modules of software instructions being executed by one or more processing units (e.g., a processor) of a computing device. In some embodiments, the modules 1610-1690 are modules of hardware circuits implemented by one or more ICs of an electronic apparatus. Though the modules 1610-1690 are illustrated as being separate modules, some of the modules can be combined into a single module.

The parser 1690 (or entropy decoder) receives the bitstream 1695 and performs initial parsing according to the syntax defined by a video-coding or image-coding standard. The parsed syntax element includes various header elements, flags, as well as quantized data (or quantized coefficients) 1612. The parser 1690 parses out the various syntax elements by using entropy-coding techniques such as context-adaptive binary arithmetic coding (CABAC) or Huffman encoding.

The inverse quantization module 1611 de-quantizes the quantized data (or quantized coefficients) 1612 to obtain transform coefficients, and the inverse transform module 1610 performs inverse transform on the transform coefficients 1616 to produce reconstructed residual signal 1619. The reconstructed residual signal 1619 is added with predicted pixel data 1613 from the intra-prediction module 1625 or the motion compensation module 1630 to produce decoded pixel data 1617. The decoded pixels data are filtered by the in-loop filter 1645 and stored in the decoded picture buffer 1650. In some embodiments, the decoded picture buffer 1650 is a storage external to the video decoder 1600. In some embodiments, the decoded picture buffer 1650 is a storage internal to the video decoder 1600.

The intra-prediction module 1625 receives intra-prediction data from bitstream 1695 and according to which, produces the predicted pixel data 1613 from the decoded pixel data 1617 stored in the decoded picture buffer 1650. In some embodiments, the decoded pixel data 1617 is also stored in a line buffer (not illustrated) for intra-picture prediction and spatial MV prediction.

In some embodiments, the content of the decoded picture buffer 1650 is used for display. A display device 1655 either retrieves the content of the decoded picture buffer 1650 for display directly, or retrieves the content of the decoded picture buffer to a display buffer. In some embodiments, the display device receives pixel values from the decoded picture buffer 1650 through a pixel transport.

The motion compensation module 1630 produces predicted pixel data 1613 from the decoded pixel data 1617 stored in the decoded picture buffer 1650 according to motion compensation MVs (MC MVs). These motion compensation MVs are decoded by adding the residual motion data received from the bitstream 1695 with predicted MVs received from the MV prediction module 1675.

The MV prediction module 1675 generates the predicted MVs based on reference MVs that were generated for decoding previous video frames, e.g., the motion compensation MVs that were used to perform motion compensation. The MV prediction module 1675 retrieves the reference MVs of previous video frames from the MV buffer 1665. The video decoder 1600 stores the motion compensation MVs generated for decoding the current video frame in the MV buffer 1665 as reference MVs for producing predicted MVs.

The in-loop filter 1645 performs filtering or smoothing operations on the decoded pixel data 1617 to reduce the artifacts of coding, particularly at boundaries of pixel blocks. In some embodiments, the filtering or smoothing operations performed by the in-loop filter 1645 include deblock filter (DBF), sample adaptive offset (SAO), and/or adaptive loop filter (ALF).

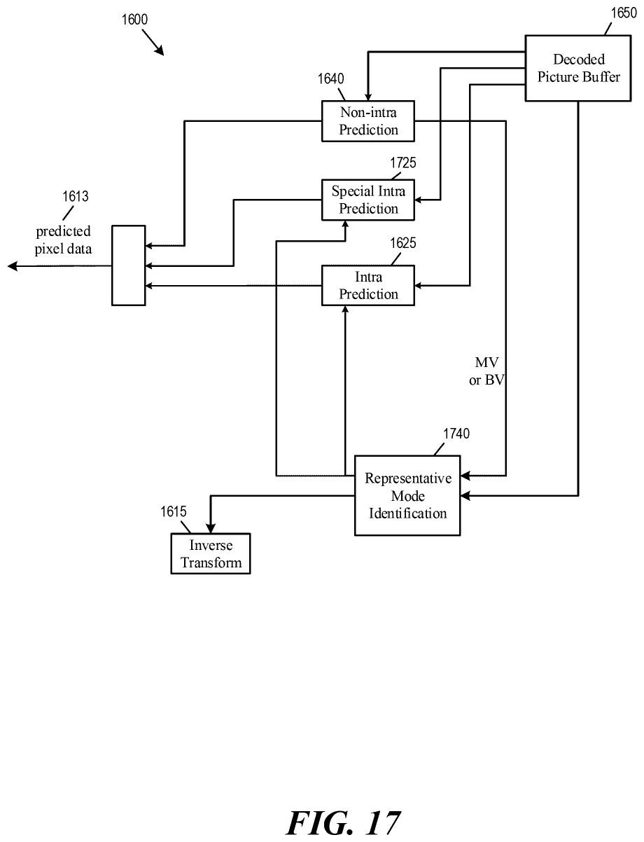

FIG. 17 illustrates portions of the video decoder 1600 that implement the representative prediction mode. As illustrated, the non-intra-prediction module (for example, inter-prediction module) 1640, the intra-prediction module 1625, and/or a special intra-prediction module 1725 retrieves pixel samples from the decoded picture buffer 1650 to produce the predictor of the current block in the predicted pixel data 1613. In some embodiments, the intra-prediction module 1625 performs prediction for regular intra modes, where traditional intra prediction, DIMD or TIMD operations may be performed to select one or more among DC, planar, and/or intra-prediction directions.

The non-intra-prediction module 1640 performs motion compensation for inter prediction modes (e.g., merge modes). In some embodiments, the non-intra-prediction module 1640 also performs prediction based on samples in the current picture as reference, such as in IBC mode. More generally, the non-intra-prediction module 1640 performs prediction for non-intra modes.

Special intra-prediction module 1725 performs prediction for special intra modes, such as MIP, CCLM, blending mode, TMP modes, or other modes that uses samples of the current picture, as reference to generate the predictor of the current block without using the traditional 67 or 131 directional intra prediction modes, whether for the same color component or a different color component.

The video decoder 1600 also includes a representative mode module 1740. The representative mode module 1740 generates or identifies a representative prediction mode for the current block by selecting from a plurality of intra prediction modes based on costs/derivation/analysis, or by searching a plurality of predefined positions within or neighboring a reference region that is identified by a block vector or motion vector (provided by the non-intra-prediction module 1640).

The representative intra-prediction mode is provided to the inverse transform module 1615 to select a transform mode. In some embodiments, the representative prediction mode is used to select a primary transform (e.g., MTS) according to Tables 4-6. In some embodiments, the representative intra-prediction mode is used to select a secondary transform (e.g., LFNST) according to FIG. 9. The representative intra-prediction mode is also stored in a storage buffer 1745 so the representative mode may or may not be used for coding a subsequent block as a most probable mode (MPM) and/or prediction generation and/or transform selection, or for coding a collocated chroma component block in chroma DM mode.

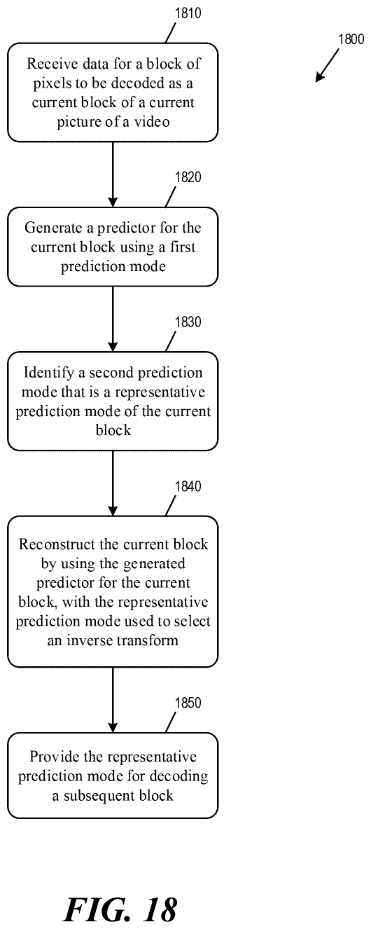

FIG. 18 conceptually illustrates a process 1800 for generating and using representative intra prediction of the current block. In some embodiments, one or more processing units (e.g., a processor) of a computing device implementing the decoder 1600 performs the process 1800 by executing instructions stored in a computer readable medium. In some embodiments, an electronic apparatus implementing the decoder 1600 performs the process 1800.

The decoder receives (at block 1810) data to be decoded as a current block of pixels in a current picture.

The decoder generates (at block 1820) a predictor for the current block using a first prediction mode. In some embodiments, the first prediction mode is not a directional intra-prediction mode. The first prediction mode may be a regular intra mode, special intra mode, and/or non-intra mode. The decoder identifies (at block 1830) a second prediction mode as a representative prediction mode of the current block.

In some embodiments, the predictor is generated under MIP mode, i.e., by matrix multiplication of a pre-defined or derived matrix with a set of input samples derived (e.g., down-sampled) from samples neighboring the current block. In some embodiments, the current block is a chroma component block and the predictor for the current block is generated by applying a cross-component model to a collocated luma component block. In some embodiments, the predictor for the current block is generated by intraTMP mode based on a reference block that is identified by matching a first template region neighboring the current block with a second template region in the current picture or in a reference picture. In some embodiments, the predictor is generated under blending mode (for example, CIIP) by combining predictions from multiple prediction hypotheses.

In some embodiments, the predictor is generated by using a block vector or a motion vector to identify a reference region in the current picture or in a reference picture and the representative prediction mode is an intra prediction mode used to code pixel samples within or neighboring the reference region. In some embodiments, the decoder identifies the representative prediction mode by searching a plurality of predefined positions within or neighboring the reference region in a predefined order for determining the representative prediction mode.

In some embodiments, the representative prediction mode is selected from a plurality of intra prediction modes based on costs/derivation/analysis, where the cost of an intra prediction mode is a difference between reconstructed samples and predicted samples of a neighboring region for the current block and the predicted samples of the neighboring region for the current block is generated based on the intra prediction mode. In some embodiments, the representative prediction mode is identified by deriving a plurality of histograms of gradients (HoGs) for a plurality of intra prediction modes, and HoG for an intra prediction mode is derived based on a pre-defined set of the predictor for the current block.

The decoder reconstructs (at block 1840) the current block by using the generated predictor for the current block, with the representative prediction mode used to select an inverse transform for the prediction residuals. In some embodiments, the representative intra-prediction mode is used to select a primary transform (e.g., MTS) according to Tables 4-6. In some embodiments, the representative intra-prediction mode is used to select a secondary transform (e.g., LFNST) according to FIG. 9. The decoder may then provide the reconstructed current block for display as part of the reconstructed current picture. In some embodiments, the representative intra-prediction mode is used to select a transform set and/or a transpose flag for secondary transform.

The decoder stores the representative prediction mode of the current block and/or provides (at block 1850) the representative prediction mode for decoding a subsequent block. For example, in some embodiments, the decoder provides the representative prediction mode for use as a most probable mode (MPM), prediction generation, and/or transform selection for coding a subsequent block. In some embodiments, the current block is a luma component block and the representative prediction mode is used to decode a collocated chroma component block in chroma DM mode, by e.g., generating an intra prediction predictor of the chroma block.

### XIII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

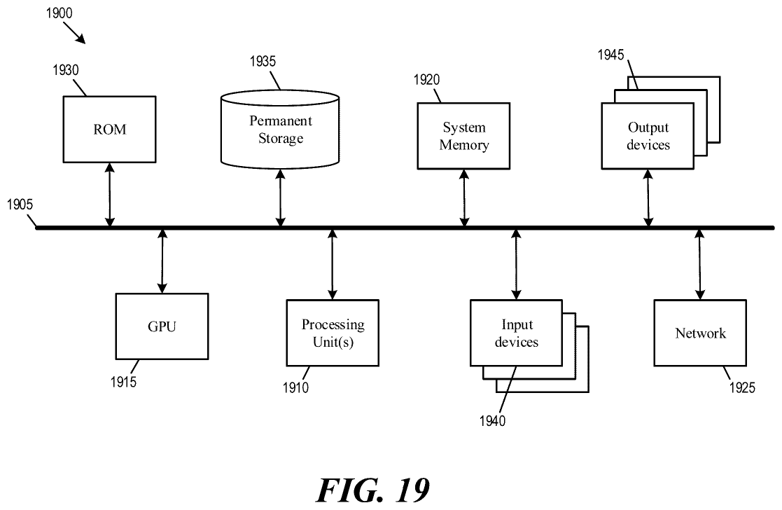

FIG. 19 conceptually illustrates an electronic system 1900 with which some embodiments of the present disclosure are implemented. The electronic system 1900 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1900 includes a bus 1905, processing unit(s) 1910, a graphics-processing unit (GPU) 1915, a system memory 1920, a network 1925, a read-only memory 1930, a permanent storage device 1935, input devices 1940, and output devices 1945.

The bus 1905 collectively represents all system, peripheral, and chipset buses that communicatively connect the numerous internal devices of the electronic system 1900. For instance, the bus 1905 communicatively connects the processing unit(s) 1910 with the GPU 1915, the read-only memory 1930, the system memory 1920, and the permanent storage device 1935.

From these various memory units, the processing unit(s) 1910 retrieves instructions to execute and data to process in order to execute the processes of the present disclosure. The processing unit(s) may be a single processor or a multi-core processor in different embodiments. Some instructions are passed to and executed by the GPU 1915. The GPU 1915 can offload various computations or complement the image processing provided by the processing unit(s) 1910.

The read-only-memory (ROM) 1930 stores static data and instructions that are used by the processing unit(s) 1910 and other modules of the electronic system. The permanent storage device 1935, on the other hand, is a read-and-write memory device. This device is a non-volatile memory unit that stores instructions and data even when the electronic system 1900 is off. Some embodiments of the present disclosure use a mass-storage device (such as a magnetic or optical disk and its corresponding disk drive) as the permanent storage device 1935.

Other embodiments use a removable storage device (such as a floppy disk, flash memory device, etc., and its corresponding disk drive) as the permanent storage device. Like the permanent storage device 1935, the system memory 1920 is a read-and-write memory device. However, unlike storage device 1935, the system memory 1920 is a volatile read-and-write memory, such a random access memory. The system memory 1920 stores some of the instructions and data that the processor uses at runtime. In some embodiments, processes in accordance with the present disclosure are stored in the system memory 1920, the permanent storage device 1935, and/or the read-only memory 1930. For example, the various memory units include instructions for processing multimedia clips in accordance with some embodiments. From these various memory units, the processing unit(s) 1910 retrieves instructions to execute and data to process in order to execute the processes of some embodiments.

The bus 1905 also connects to the input and output devices 1940 and 1945. The input devices 1940 enable the user to communicate information and select commands to the electronic system. The input devices 1940 include alphanumeric keyboards and pointing devices (also called “cursor control devices”), cameras (e.g., webcams), microphones or similar devices for receiving voice commands, etc. The output devices 1945 display images generated by the electronic system or otherwise output data. The output devices 1945 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 19, bus 1905 also couples electronic system 1900 to a network 1925 through a network adapter (not shown). In this manner, the computer can be a part of a network of computers (such as a local area network (“LAN”), a wide area network (“WAN”), or an Intranet, or a network of networks, such as the Internet. Any or all components of electronic system 1900 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 15 and FIG. 18) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A video coding method comprising:
receiving data for a block of pixels to be encoded or decoded as a current block of a current picture of a video;
generating a predictor for the current block using a first prediction mode;
identifying a second prediction mode as a representative prediction mode of the current block; and
encoding or decoding the current block by using the generated predictor for the current block and the representative prediction mode.

2. The video coding method of claim 1, wherein the first prediction mode is not a directional intra-prediction mode.

3. The video coding method of claim 1, wherein the representative prediction mode is selected from a plurality of intra prediction modes based on costs, wherein the cost of an intra prediction mode is a difference between reconstructed samples and predicted samples of a neighboring region for the current block and the predicted samples of the neighboring region for the current block is generated based on the intra prediction mode.

4. The video coding method of claim 1, wherein the predictor for the current block is generated by using a block vector or a motion vector to identify a reference region in the current picture or in a reference picture and the representative prediction mode is an intra prediction mode used to encode or decode pixel samples within or neighboring the reference region.

5. The video coding method of claim 4, wherein identifying the representative prediction mode comprises searching a plurality of predefined positions within or neighboring the reference region in a predefined order for determining the representative prediction mode.

6. The video coding method of claim 1, wherein identifying the representative prediction mode comprises deriving a plurality of histograms of gradients (HoGs) for a plurality of intra prediction modes, wherein HoG for an intra prediction mode is derived based on a pre-defined set of the predictor for the current block.

7. The video coding method of claim 1, wherein encoding or decoding the current block comprises using a transform mode that is selected based on the representative prediction mode to perform transform or inverse transform for residuals of the predictor for the current block or transformed coefficients of the residuals for the current block.

8. The video coding method of claim 7, wherein the representative prediction mode is used to select a transform set, a transpose flag, or both for non-separable transform.

9. The video coding method of claim 1, further comprising providing the representative prediction mode for use as a most probable mode (MPM) for encoding or decoding a subsequent block.

10. The video coding method of claim 1, wherein the current block is a luma component block and the representative prediction mode is used to encode or decode a collocated chroma component block.

11. The video coding method of claim 1, wherein the predictor for the current block is generated by matrix multiplication of a pre-defined or derived matrix and a set of input samples derived from samples neighboring the current block.

12. The video coding method of claim 1, wherein the current block is a chroma component block and the predictor for the current block is generated by applying a cross-component model to a collocated luma component block.

13. The video coding method of claim 1, wherein the predictor for the current block is generated based on a reference block that is identified by matching a first template region neighboring the current block with a second template region in the current picture or in a reference picture.

14. The video coding method of claim 1, wherein the predictor for the current block is generated by combining predictions from multiple prediction hypotheses.

15. A video coder circuit configured to perform operations comprising:
receiving data for a block of pixels to be encoded or decoded as a current block of a current picture of a video;
generating a predictor for the current block using a first prediction mode;
identifying a second prediction mode as a representative prediction mode of the current block; and
encoding or decoding the current block by using the generated predictor for the current block and the representative prediction mode.

16-17. (canceled)
